(19) United States
(12) Patent Application Publication
(10) Pub. No.: US 2021/0397662 A1
(43) Pub. Date: Dec. 23, 2021

(54) SEARCH NEEDS EVALUATION APPARATUS, SEARCH NEEDS EVALUATION SYSTEM, AND SEARCH NEEDS EVALUATION METHOD

(71) Applicant: Datascientist Inc., Tokyo (JP)

(72) Inventors: Naoya SAKAKIBARA, Tokyo (JP); Yuki HIROBE, Tokyo (JP)

(73) Assignee: Datascientist Inc., Tokyo (JP)

(21) Appl. No.: 17/291,355

(22) PCT Filed: Nov. 6, 2018
(86) PCT No.: PCT/JP2018/041100

§ 371 Date: May 5, 2021

(51) Int. Cl. G06F 16/958; G06F 16/957; G06F 16/906; G06F 16/9535; G06F 16/9538

(52) U.S. Cl. CPC G06F 16/958; G06F 16/9577; G06F 16/9538; G06F 16/9535; G06F 16/906

(57) ABSTRACT

By showing information that can infer the search intent, it will be possible to develop products and create Web pages that match the search intent.

A search needs evaluation apparatus acquires a plurality of document data and converts the contents or the structure of the plurality of document data into feature vector data. The search needs evaluation apparatus performs a process on the feature vector data according to a predetermined statistical identification algorithm, and classifies a plurality of document data into a plurality of subsets. The search needs evaluation apparatus outputs the analysis result of the property of search needs based on the relationship between a plurality of subsets.

### TECHNICAL FIELD

The present invention relates to a technique for evaluating a search intent (hereinafter, appropriately referred to as “search needs”) of a word used as a search word of a search engine.

### BACKGROUND ART

Google (registered trademark) technology utilizes search results and various behavioral data displayed in the search results (specifically, click rate, time spent on the site, etc.) to determine the search ranking. In a search engine, which is a service based on this technology, the greater number of times the screen is clicked and longer the user stays at the site, the more likely it is for the search ranking to rise. Details of this technique are disclosed in Patent Literature 1 (particularly, paragraphs 0088-0090). A search engine optimization (SEO) is one of the methods to adjust the structure of a Web site so that a specific website is displayed at the top ranking in the search results of a search engine. Patent Literature 2 is a document that discloses technology related to the SEO. In the Web page analyzer of Patent Literature 2, when a word is inputted as a target keyword, each of the plurality of Web page data in the search result for the target keyword is used as the analysis target Web page, the morphological analysis process is performed on the analysis target Web page, the content number of each morpheme of the same type in the morpheme group obtained by the morphological analysis process is totaled, the evaluation value for each morpheme, which indicates the degree of contribution of each morpheme to the ranking of the analysis target Web page in the search results, is obtained, and a list of evaluation values for each morpheme lined up for each analysis target Web page is presented as an analysis result. According to the technique of Patent Literature 2, a morpheme having a high SEO effect can be efficiently found.

### CITATION LIST

### Patent Literature

Patent Literature 1: US 2012/0209838 A1

Patent Literature 2: JP 6164436 B

### SUMMARY OF INVENTION

### Technical Problem

However, in this technique (Patent Literature 2), when one target search keyword is used in a plurality of different search needs, it is not possible to obtain a clear analysis result for each of the plurality of search needs. In other words, since a plurality of Web page data in the search results is analyzed together without considering the existence of a plurality of different search needs, there is a problem in that it is not possible to obtain an appropriate evaluation value for each morpheme for each search need.

The present invention has been made in view of such problems, and an object of the present invention is to provide a technical means for supporting analysis of the property of search needs.

### Solution to Problem

According to one embodiment of the present invention, provided is a search needs evaluation apparatus comprising: a similarity acquisition means that acquires, based on a search result for each of a plurality of search words, a similarity of search needs between each search word; and a display control means that displays a screen including a node and an edge, each search word being associated with the node, the edge connecting the nodes, wherein a length of the edge corresponds to a similarity between the search words associated with the nodes connected through the edge.

The display control means may move a specific node according to a user operation, and move at least one node connected to the specific node through an edge according to a movement of the specific node.

The search needs evaluation apparatus may comprise: an identification means that classifies each search word into a cluster based on a search result for each of the plurality of search words, wherein the display control means may display a node in a display mode corresponding to a cluster into which each search word is classified.

The identification means may be capable of calculating how close each search word is to each of two or more of the clusters, and the display control means may display a node in a display mode according to how close each search word is to which cluster.

The identification means may be capable of classifying each search word into a cluster with a plurality of stages of granularity, and each time a granularity may be set according to a user operation, classifies each search word into a cluster according to the set granularity.

The display control means may change a display mode of a node when a granularity is changed according to a user operation and thus a cluster into which each search word is classified changes.

The display control means may display a node in a display mode according to a number of searches for each search word in a certain period.

The search needs evaluation apparatus may comprise: a quantification means that converts at least one of a content and a structure of document data which is a search result for each of a plurality of search words into multidimensional feature vector data, wherein the similarity acquisition means may acquire a similarity between each search word based on a similarity between the feature vector data for each search word.

According to another embodiment of the present invention, provided is a search needs evaluation method comprising the steps of: by a similarity acquisition means, acquiring, based on a search result for each of a plurality of search words, a similarity of search needs between each search word; and by a display control means, displaying a screen including a node and an edge, each search word being associated with the node, the edge connecting the nodes, wherein a length of the edge corresponds to a similarity between the search words associated with the nodes connected through the edge.

According to another embodiment of the present invention, provided is a search needs evaluation program causing a computer to function as a similarity acquisition means that acquires, based on a search result for each of a plurality of search words, a similarity of search needs between each search word, and a display control means that displays a screen including a node and an edge, each search word being associated with the node, the edge connecting the nodes, wherein a length of the edge corresponds to a similarity between the search words associated with the nodes connected through the edge.

According to another embodiment of the present invention, provided is a search needs evaluation apparatus comprising: an acquisition means that acquires a plurality of document data in a search result based on a certain search word; a quantification means that converts at least one of a content and a structure of the plurality of document data into multidimensional feature vector data; an identification classification means that classifies the plurality of document data into a plurality of subsets based on the feature vector data; and an analysis result output means that outputs an analysis result of a property of search needs based on a relationship between the plurality of subsets.

The identification classification means may perform a process on the feature vector data according to a clustering algorithm or a class classification algorithm, and classifies the plurality of document data into a plurality of subsets.

The acquisition means may acquire document data in a search result for each search word for each of a plurality of search words, the quantification means may convert at least one of a content and a structure of the plurality of document data in the search result for each search word into multidimensional feature vector data, and the search needs evaluation apparatus may include a combining means that performs a predetermined statistical process on feature vector data for each document obtained by the quantification means, and that combines the feature vector data for each search word.

The acquisition means may acquire document data in a search result for each search word for each of a plurality of search words, the quantification means may convert at least one of a content and a structure of the plurality of document data in the search result for each search word into multidimensional feature vector data, the identification means may classify the plurality of document data into a plurality of subsets based on feature vector data for each document, and

the search needs evaluation apparatus includes a combining means that performs a predetermined statistical process on a processing result by the identification means, and that combines the processing result for each search word.

The search needs evaluation apparatus may comprise: a dimension reduction means that dimensionally reduces the feature vector data to lower dimensional feature vector data, wherein the identification means classifies the plurality of document data into a plurality of subsets based on the feature vector data that has undergone the dimension reduction by the dimension reduction means.

According to another embodiment of the present invention, provided is a search needs evaluation apparatus comprising: an acquisition means that acquires a plurality of document data in a search result based on a certain search word; a quantification means that converts at least one of a content and a structure of the plurality of document data into multidimensional feature vector data; a similarity identification means that identifies a similarity between feature vector data of the plurality of document data; a community detection means that classifies the plurality of document data into a plurality of communities based on the similarity; and an analysis result output means that outputs an analysis result of search needs based on a relationship between the plurality of communities.

The acquisition means may acquire document data in a search result for each search word for each of a plurality of search words, the quantification means may convert at least one of a content and a structure of the plurality of document data in the search result for each search word into multidimensional feature vector data, the similarity identification means may identify a similarity between feature vector data of the plurality of document data for each search word, the community detection means may classify the plurality of document data for each search word into a plurality of communities based on the similarity between the feature vector data of the plurality of document data for each search word, and the search needs evaluation apparatus may include a combining means that performs a predetermined statistical process on a processing result of a community detection for each search word by the community detection means, and that combines the processing result of the community detection for each search word.

According to another embodiment of the present invention, provided is a search needs evaluation method comprising: an acquisition step of acquiring a plurality of document data in a search result based on a certain search word; a quantification step of converting at least one of a content and a structure of the plurality of document data into multidimensional feature vector data; an identification step of classifying the plurality of document data into a plurality of subsets based on the feature vector data; and an analysis result output step of outputting an analysis result of a property of search needs based on a relationship between the plurality of subsets.

According to another embodiment of the present invention, provided is a search needs evaluation method comprising: an acquisition step of acquiring a plurality of document data in a search result based on a certain search word; a quantification step of converting at least one of a content and a structure of the plurality of document data into multidimensional feature vector data; a similarity identification step of identifying a similarity between feature vector data of the plurality of document data; a community detection step of classifying the plurality of document data into a plurality of communities based on the similarity; and an analysis result output step of outputting an analysis result of search needs based on a relationship between the plurality of communities.

According to another embodiment of the present invention, provided is a search needs evaluation program causing a computer to execute: an acquisition step of acquiring a plurality of document data in a search result based on a certain search word; a quantification step of converting at least one of a content and a structure of the plurality of document data into multidimensional feature vector data; an identification step of classifying the plurality of document data into a plurality of subsets based on the feature vector data; and an analysis result output step of outputting an analysis result of a property of search needs based on a relationship between the plurality of subsets.

Provided is a search needs evaluation program causing a computer to execute: an acquisition step of acquiring a plurality of document data in a search result based on a certain search word; a quantification step of converting at least one of a content and a structure of the plurality of document data into multidimensional feature vector data; a similarity identification step of identifying a similarity between feature vector data of the plurality of document data; a community detection step of classifying the plurality of document data into a plurality of communities based on the similarity; and an analysis result output step of outputting an analysis result of search needs based on a relationship between the plurality of communities.

### Advantageous Effects of Invention

According to the present invention, it is possible to quantitatively evaluate or display the variety of search needs for each search word. In addition, in the conventional technology, the evaluation of morphemes contained in the search result Web page, which was evaluated only for each search word, can be evaluated for each search needs, so that it will be easier to create commentary texts, web pages, and the like that meet the search needs.

### BRIEF DESCRIPTION OF DRAWINGS

FIG. 1 is a diagram showing an overall configuration of an evaluation system including a search needs evaluation apparatus according to a first embodiment of the present invention.

FIG. 2 is a flowchart showing a flow of an evaluation method executed by the CPU of the search needs evaluation apparatus according to the evaluation program according to the first embodiment of the present invention.

FIG. 3 is a diagram showing a procedure of a clustering process of the search needs evaluation apparatus according to the first embodiment of the present invention.

FIG. 4 is a diagram showing a procedure for setting an evaluation axis of the search needs evaluation apparatus according to the first embodiment of the present invention.

FIG. 5 is a diagram showing an outline of a process of the search needs evaluation apparatus according to a first embodiment of the present invention.

FIG. 6 is a flowchart showing a flow of an evaluation method executed by the CPU of the search needs evaluation apparatus according to the evaluation program according to a second embodiment of the present invention.

FIG. 7 is a diagram showing a procedure of a classification process of a search needs evaluation apparatus according to a second embodiment of the present invention.

FIG. 8 is a diagram showing an outline of a process of the search needs evaluation apparatus according to a second embodiment of the present invention.

FIG. 9 is a flowchart showing a flow of an evaluation method executed by the CPU of a search needs evaluation apparatus according to the evaluation program according to a third embodiment of the present invention.

FIG. 10 is a diagram showing an outline of a process of the search needs evaluation apparatus according to a third embodiment of the present invention.

FIG. 11 is a flowchart showing a flow of an evaluation method executed by the CPU of a search needs evaluation apparatus according to the evaluation program according to a fourth embodiment of the present invention.

FIG. 12 is a diagram showing an outline of a process of the search needs evaluation apparatus according to the fourth embodiment of the present invention.

FIG. 13 is a flowchart showing a flow of an evaluation method executed by the CPU of a search needs evaluation apparatus according to the evaluation program according to a fifth embodiment of the present invention.

FIG. 14 is a diagram showing an outline of a process of the search needs evaluation apparatus according to the fifth embodiment of the present invention.

FIG. 15 is a flowchart showing a flow of an evaluation method executed by the CPU of a search needs evaluation apparatus according to the evaluation program according to a sixth embodiment of the present invention.

FIG. 16 is a diagram showing an outline of a process of the search needs evaluation apparatus according to the sixth embodiment of the present invention.

FIG. 17 is a flowchart showing a flow of an evaluation method executed by the CPU of a search needs evaluation apparatus according to the evaluation program according to a seventh embodiment of the present invention.

FIG. 18 is a diagram showing an outline of a process of the search needs evaluation apparatus according to the seventh embodiment of the present invention.

FIG. 19 is a flowchart showing a flow of an evaluation method executed by the CPU of a search needs evaluation apparatus according to an evaluation program according to an eighth embodiment of the present invention.

FIG. 20 is a diagram showing an outline of a process of the search needs evaluation apparatus according to the eighth embodiment of the present invention.

FIG. 21 is a flowchart showing a flow of an evaluation method executed by the CPU of a search needs evaluation apparatus according to the evaluation program according to a ninth embodiment of the present invention.

FIG. 22 is a diagram showing an outline of a process of the search needs evaluation apparatus according to the ninth embodiment of the present invention.

FIG. 23 is a diagram showing a processing content of a search needs evaluation apparatus which is a modification of the present invention.

FIG. 24 is a diagram showing a processing content of a search needs evaluation apparatus which is the modification of the present invention.

FIG. 25 is a diagram showing a mapping image 7 of FIG. 11 more specifically.

FIG. 26 is a diagram showing a state in which the node n3 associated with the “ABC business” in FIG. 25 is moved.

FIG. 27 is a diagram showing the mapping image 7 in which search words are classified into clusters and nodes are displayed in a display mode according to the classified clusters.

FIG. 28 is a diagram showing the mapping image 7 when a search word can be classified into a plurality of clusters instead of being determined to be classified into one cluster.

FIG. 29 is a diagram showing the mapping image 7 in which the user can set the granularity.

FIG. 30 is a diagram showing a state in which the granularity is set to be finer than in FIG. 29.

FIG. 31 is a diagram showing an example of a granularity adjustment interface.

FIG. 32 is a diagram showing an example of a granularity adjustment interface.

FIG. 33 is a diagram showing an example of a granularity adjustment interface.

FIG. 34 is a diagram showing an example of a granularity adjustment interface.

FIG. 35 is a diagram showing an example of a granularity adjustment interface.

FIG. 36 is a diagram showing a mapping image 7 in which nodes are displayed in a style corresponding to the number of searches for each search word.

FIG. 37 is a diagram showing an example of a screen when the analysis result is displayed in a table format.

FIG. 38 is a diagram showing a state in which the granularity of FIG. 37 is coarsened.

FIG. 39 is a diagram showing an example of a screen when the analysis result is displayed in a correlation matrix format.

FIG. 40 is a diagram showing a state in which the search words in FIG. 39 are sorted.

FIG. 41 is a diagram showing an example of a screen when the analysis result is displayed in a dendrogram format.

FIG. 42 is a diagram showing a state in which the granularity setting bar 36 of FIG. 41 is moved.

FIG. 43 is a diagram showing an example of a screen when the analysis result is displayed in a tree map format.

FIG. 44 is a diagram showing an example of a screen when the analysis result is displayed in a sunburst format.

### DESCRIPTION OF EMBODIMENTS

Hereinafter, embodiments of the present invention will be described with reference to the drawings.

### First Embodiment

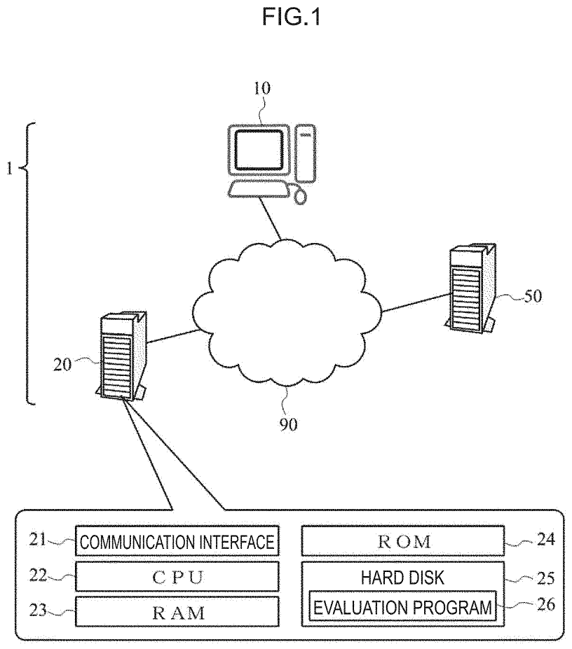

FIG. 1 is a diagram showing an overall configuration of an evaluation system 1 including a search needs evaluation apparatus 20 according to the first embodiment of the present invention. As shown in FIG. 1, the evaluation system 1 includes a user terminal 10 and the search needs evaluation apparatus 20. The user terminal 10 and the search needs evaluation apparatus 20 are connected via the Internet 90. A search engine server apparatus 50 is connected to the Internet 90.

The search engine server apparatus 50 is an apparatus that plays a role of providing a search engine service. The search engine server apparatus 50 crawls the Internet 90, and performs a crawl process of indexing information obtained from web pages scattered as document data (data written in a markup language such as a hypertext markup language (HTML)) on the Internet 90, and a search process of receiving a hypertext transfer protocol (HTTP) request (search query) containing the search word from the searcher's computer and returning the search result in which sets of a web page title, a uniform resource locator (URL), and a snippet that are searched for using the search word in the search query are arranged in order from the highest ranking (ranking is high). Although only one search engine server apparatus 50 is shown in FIG. 1, the number of search engine server apparatuses 50 may be plural.

The user terminal 10 is a personal computer. A unique ID and a unique password are assigned to the user of the user terminal 10. The user accesses the search needs evaluation apparatus 20 from his/her own user terminal 10 to authenticate, and uses the service of the search needs evaluation apparatus 20. Although only one user terminal 10 is shown in FIG. 1, the number of user terminals 10 in the evaluation system 1 may be plural.

The search needs evaluation apparatus 20 is an apparatus that plays a role of providing a search needs evaluation service. The search needs evaluation service is a service in which the search word to be evaluated is received from the user, and the top d ranking (d is a natural number of 2 or more) web pages in the search result of the search word are classified by a predetermined statistical identification processing algorithm, and a set of a plurality of web pages obtained by this identification is presented as an analysis result.

As shown in FIG. 1, the search needs evaluation apparatus 20 includes a communication interface 21, a central processing unit (CPU) 22, a random access memory (RAM) 23, a read only memory (ROM) 24, and a hard disk 25. The communication interface 21 transmits/receives data to/from an apparatus connected to the Internet 90. The CPU 22 executes various programs stored in the ROM 24 and hard disk 25 while using the RAM 23 as a work area. An initial program loader (IPL) and the like are stored in the ROM 24. The hard disk 25 stores an evaluation program 26 having a function peculiar to the present embodiment.

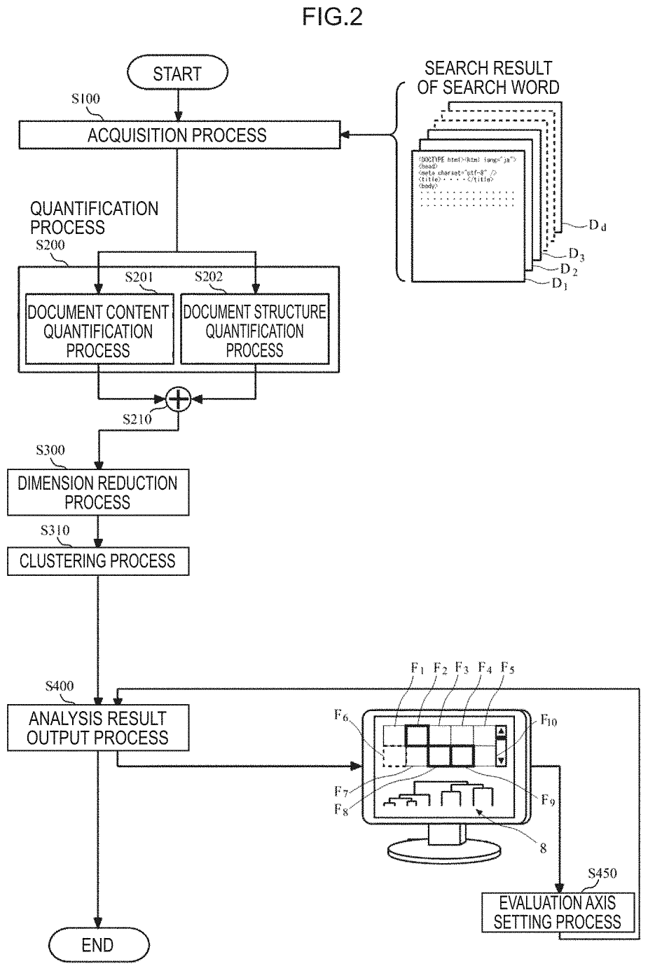

Next, the operation of the embodiment will be described. FIG. 2 is a flowchart showing the flow of the evaluation method executed by the CPU 22 of the search needs evaluation apparatus 20 according to the evaluation program 26. By executing the evaluation program 26, the CPU 22 functions as an acquisition means that performs an acquisition process (S100), a quantification means that performs a quantification process (S200), an addition means that performs an addition process (S210), a dimension reduction means that performs a dimension reduction process (S300), a identification means that performs a clustering process (S310), an analysis result output means that performs an analysis result output process (S400), and an evaluation axis setting means that performs an evaluation axis setting process (S450).

In the acquisition process in step S100, the CPU 22 receives the search word to be evaluated from the user terminal 10, and acquires the document data Dₖ (k=1 to d, k is an index indicating the ranking) of the top d ranking web pages in the search result based on the search words to be evaluated. The document data Dₖ (k=1 to d) describes the content and the structure of the k-th ranking web page in the search results in HTML. In the following, the document data Dₖ (k=1 to d) will be appropriately referred to as document data D₁, D₂ . . . D_{d}.

The quantification process in step S200 includes a document content quantification process (S201) and a document structure quantification process (S202). The document content quantification process is a process of converting the contents of the document data D₁, D₂ . . . D_{d} into n-dimensional feature vector data (n is a natural number of 2 or more). The document structure quantification process is a process of converting the structure of the document data D₁, D₂ . . . D_{d} into m-dimensional feature vector data (m is a natural number of 2 or more). In the following, the n-dimensional feature vector data of each content of the document data D₁, D₂ . . . D_{d} is described as the feature vector data x₁={x₁₁, x₁₂ . . . X₁ₙ}, x₂={x₂₁, x₂₂ . . . x₂ₙ} . . . x_{d}={x_{d1}, x_{d2} . . . x_{dn}}. In addition, the m-dimensional feature vector data of each structure of the document data D₁, D₂ . . . D_{d} is described as the feature vector data y₁={y₁₁, y₁₂ . . . y₁ₘ}, y₂={y₂₁, y₂₂ . . . y₂ₘ} . . . y_{d}={y_{d1}, y₂ . . . y_{dm}}.

To explain in more detail, in document content quantification process, the CPU 22 converts the document data D₁ into a multidimensional vector according to an algorithm such as a Bag of Words (BoW), a dmpv (Distributed Memory), or a DBoW (Distributed BoW), and sets the processing result as the feature vector data x₁={x₁₁, x₁₂ . . . x₁ₙ}, x₂={x₂₁, x₂₂ . . . x₂ₙ} . . . x_{d}={x_{d1}, x_{d2} . . . x_{dn}}. The CPU 22 converts the document data D₂ . . . D_{d} into a multidimensional vector according to a similar algorithm, and sets this processing result as the respective feature vector data x₂={x₂₁, x₂₂ . . . x₂ₙ} . . . x_{d}={x_{d1}, x_{d2} . . . x_{dn}} of the document data D₂ . . . D_{d}. Here, the dmpv and the DBoW are a kind of a Doc2Vec.

In the document structure quantification process, the CPU 22 converts the document data D₁ into a multidimensional vector according to an algorithm such as a Hidden Markov Model (HMM), a Probabilistic Context-free Grammar (PCFGP), a Recurrent Neural Network, or a Recursive Neural Network, let this processing result be the feature vector data y₁={y₁₁, y₁₂ . . . y₁ₘ} of the document data D₁. The CPU 22 converts the document data D₂ . . . D_{d} into a multidimensional vector according to a similar algorithm, and sets this processing result as the respective feature vector data y₂={y₂₁, y₂₂ . . . y₂ₘ} . . . Y_{d}={y_{d1}, y_{d2} . . . y_{dm}} of the document data D₂ . . . D_{d}.

The addition process in step S210 is a process of adding the processing result in step S201 and the processing result in step S202, and outputting the l-dimensional feature vector data (1=n+m). In the following, the l-dimensional feature vector data obtained by the addition process for each of the document data D₁, D₂ . . . D_{d} is described as the feature vector data z₁={z₁₁, z₁₂ . . . z₁ₗ}, z₂={z₂₁, z₂₂ . . . z₂ₗ} . . . z_{d}={z_{d1}, z_{d2} . . . z_{dl}}.

The dimension reduction process in step S300 is a process of dimensionally reducing the feature vector data z₁={z₁₁, z₁₂ . . . z₁ₗ}, z₂={z₂₁, z₂₂ . . . z₂ₗ} . . . z_{d}={z_{d1}, z_{d2} . . . z_{dl}} to the l′ dimensional feature vector data with a smaller number of dimensions according to an algorithms such as an autoencoder or a principal component analysis. In the following, the l′ dimensional feature vector data obtained by dimensionally reducing each of the document data D₁, D₂ . . . D_{d} is described as the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}}.

The clustering process in step S310 is a statistical identification process of classifying the document data D₁, D₂ . . . D_{d} into a plurality of subsets (group) called a cluster. In the clustering process, the CPU 22 performs a process on the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}} of the document data D₁, D₂ . . . D_{d} according to the algorithm of the nearest neighbor method of clustering to classify the document data D₁, D₂ . . . D_{d} into a plurality of clusters.

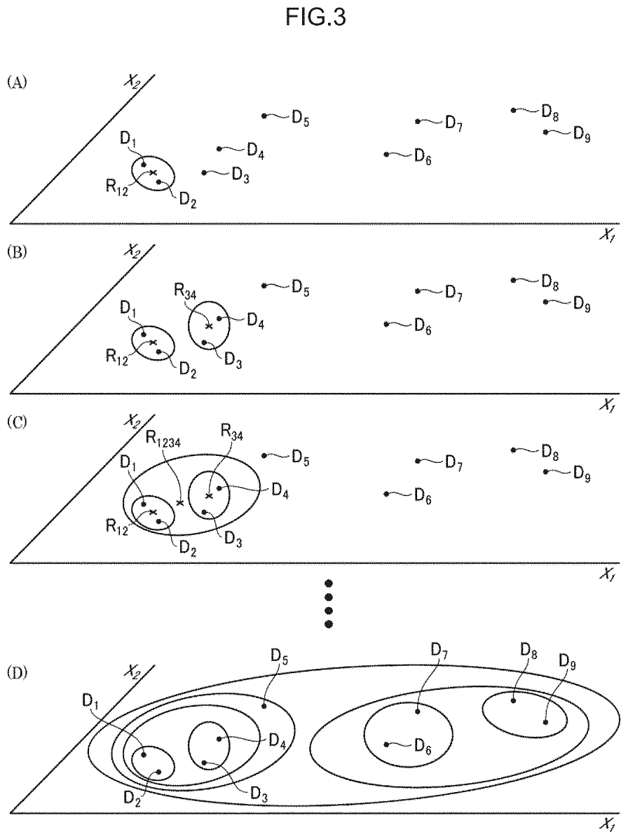

The details of the nearest neighbor method of clustering will be described. FIG. 3(A), FIG. 3(B), FIG. 3(C), and FIG. 3(D) shows the identification example when the number d of the document data Dₖ is d=9 and the number of dimensions l′ is l′=2. In clustering, the distance between the two document data Dₖ is obtained for all combinations of the two document data Dₖ in the document data Dₖ (k=1 to d). The distance between the two document data Dₖ may be the Euclidean distance, the Minkowski distance, or the Mahalanobis distance.

As shown in FIG. 3(A), the two document data Dₖ (D₁ and D₂ in the example of FIG. 3(A)) that are nearest to each other are grouped as the first cluster. After grouped as the cluster, the representative point R (center of gravity) of the cluster is obtained, and the distance between the representative point R and the document data Dₖ outside the cluster (in the example of FIG. 3(A), the document data D₃, D₄, D₅, D₆, D₇, D₈, D₉) is obtained.

As shown in FIG. 3(B), when there are two document data Dₖ outside the cluster whose distance between each other is shorter than the distance to the representative point R (in the example of FIG. 3(B), document data D₃ and D₄), the two document data Dₖ grouped into a new cluster. Also, as shown in FIG. 3(C), when there are two clusters whose representative point R is shorter than the distance to the document data Dₖ outside the cluster (in the example of FIG. 3(C), the cluster of the document data D₁ and D₂ and the cluster of the document data D₃ and D₄), the two clusters into are grouped a new cluster. As shown in FIG. 3(D), the above process is recursively repeated to generate a plurality of clusters having a hierarchical structure.

In FIG. 2, the analysis result output process in step S400 is a process of outputting the analysis result of the property of search needs related to the search word to be evaluated based on the relationship between the clusters. As shown in FIG. 2, in the analysis result output process, the CPU 22 transmits the HTML data of the analysis result screen to the user terminal 10 and displays the analysis result screen on the display of the user terminal 10. The analysis result screen has a top-ranking page identification and a dendrogram 8. In the top ranking page identification, 5 frames Fₖ (k=1 to d) in which the summary (title, snippet) of each of the top d ranking web pages in the search results based on the search word to be evaluated is internally described are aligned in a row in matrix. In FIG. 2, only the frames F₁ to F₁₀ of the first to tenth ranked web pages are displayed, but the frames Fₖ of the eleventh and subsequent ranked web pages can also be made to appear by operating the scroll bar. The frame Fₖ (k=1 to d) of the web page in the top-ranking page identification is color-coded so that the frames distributed to the same cluster by clustering have the same color. For convenience, in FIG. 2, the first color frames Fₖ (in the example in FIG. 2, the first ranked frame F₁, the third ranked frame F₃, the fourth ranked frame F₄, the fifth ranked frame F₅, the seventh ranked frame F₇, the tenth ranked frame F₁₀) are indicated by a thin line, the second color frames Fₖ (in the example of FIG. 2, the second ranked frame F₂, the eighth ranked frame F₈, the ninth ranked frame F₉) are indicated by a thick line, and the third color frame Fₖ (in the example of FIG. 2, the sixth ranked frame F₆) is indicated by a chain line. The dendrogram 8 shows the hierarchical structure of clusters obtained in the process of clustering.

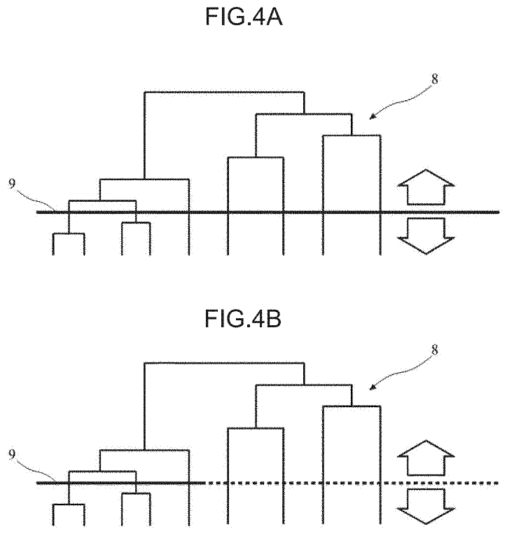

The evaluation axis setting process in step S450 is a process of setting the evaluation axis of the clustering process. As shown in FIG. 4(A), there is an evaluation axis setting bar 9 on the dendrogram 8 of the analysis result screen. The evaluation axis setting bar 9 serves to specify the number of clusters in the clustering process. The evaluation axis setting bar 9 can be moved up and down by operating the pointing device of the user terminal 10. The user moves the evaluation axis setting bar 9 to the upper (top hierarchy) side when the user wants to obtain the analysis result when the granularity of the identification is coarse. In addition, the user moves the evaluation axis setting bar 9 to the lower (lower hierarchy) side when the user wants to obtain the analysis result when the granularity of the identification is fine. When the user performs the operation to move the evaluation axis setting bar 9, the CPU 22 has a new setting at the intersection position between the evaluation axis setting bar 9 after movement and the vertical line of the dendrogram 8, and executes the clustering process based on this new setting to output the analysis result including the processing result of the clustering process.

The above is the details of the embodiment. According to the embodiment, the following effects can be obtained.

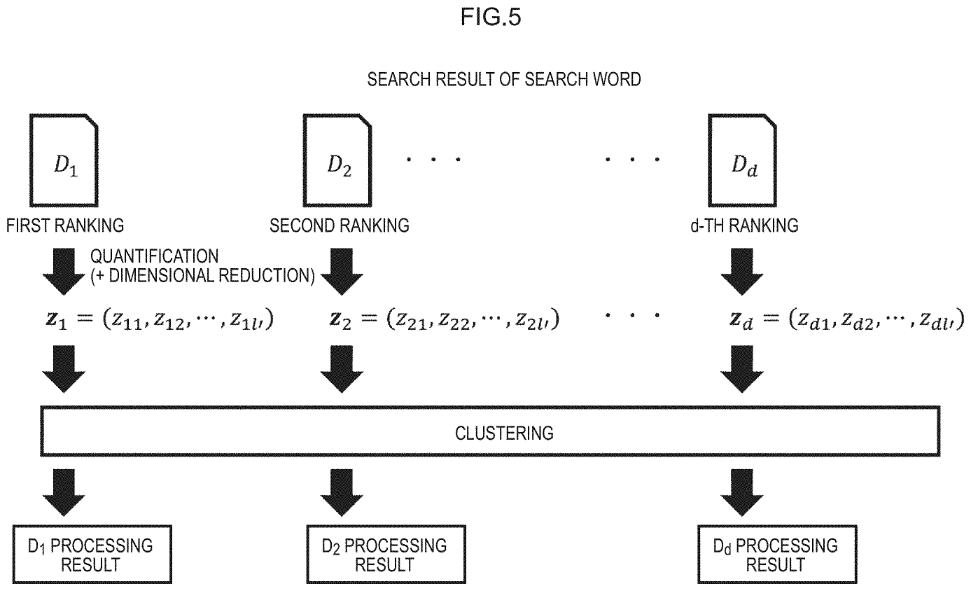

First, in the embodiment, as shown in FIG. 5, the CPU 22 converts the content and the structure of the d pieces of top ranking document data D₁, D₂ . . . D_{d} in the search results of one search word to be evaluated into the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}}, performs the clustering process on the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}}, and classifies the document data D₁, D₂ . . . D_{d} into a plurality of subsets a(clusters). The CPU 22 outputs the analysis result of the property of search needs based on the relationship between a plurality of subsets which is the processing result of clustering of the document data D₁, D₂ . . . D_{d}. Therefore, according to the present embodiment, it is possible to efficiently analyze how much different needs are mixed in the words of the search word and what the property of needs is.

Second, in the present embodiment, the top-ranking page identification is outputted as the analysis result. The information of the web pages in the top-ranking page identification is color-coded so that the information distributed to the same subset (cluster) by clustering has the same color. In the present embodiment, the degree of variation in the property of needs for the search word to be evaluated can be visualized by this top-ranking page identification. According to the embodiment, in the case of verifying why the top-ranking web page is ranked higher from the difference between the top-ranking web page and the lower web page in the search result, web pages having the same property of search needs can be compared. Therefore, in the present embodiment, the top-ranking web page can be verified more efficiently.

Third, in the present embodiment, the dendrogram 8 is outputted as the analysis result. When the operation to move the evaluation axis setting bar 9 in this dendrogram 8 is performed, the intersection position between the evaluation axis setting bar 9 and the vertical line of the dendrogram 8 is set as a new setting, and the clustering process is performed based on this new setting to output the analysis result including the processing result of the clustering process. Therefore, according to the present embodiment, the user can adjust the granularity of the identification in the top-ranking page identification so as to match an intention of the user.

### Second Embodiment

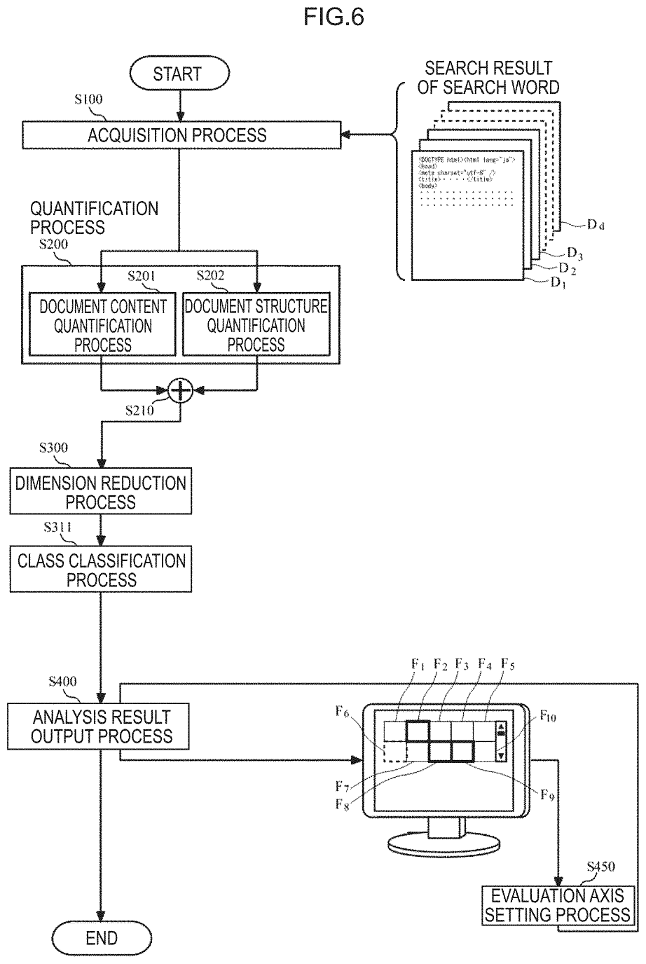

The second embodiment of the present invention will be described. FIG. 6 is a flowchart showing the flow of the evaluation method executed by the CPU 22 of the search needs evaluation apparatus 20 of the second embodiment according to the evaluation program 26. By executing the evaluation program 26, the CPU 22 functions as an acquisition means that performs an acquisition process (S100), a quantification means that performs a quantification process (S200), an addition means that performs an addition process (S210), a dimension reduction means that performs a dimension reduction process (S300), a identification means that performs a classification process (S311), and an analysis result output means that performs an analysis result output process (S400). The contents of the acquisition process, the quantification process, the addition process, and the dimension reduction process are the same as those in the first embodiment.

Comparing FIG. 6 with FIG. 2 of the first embodiment, in FIG. 6, the clustering process in step S310 is replaced with the classification process in step S311.

The classification process in step S311 is a statistical identification process of classifying the document data D₁, D₂ . . . D_{d} into a plurality of subsets (group) called classes. In the classification process, the CPU 22 performs a process on the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}} of the document data D₁, D₂ . . . D_{d} according to the classification algorithm to classify the document data D₁, D₂ . . . D_{d} into a plurality of classes.

The details of classification will be explained. In classification, the weighting coefficients w₀, w₁, w₂ . . . w_{d} of the linear classifier f(z) shown in the following equation (1) are set by machine learning using the feature vector data group of the known class, and the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}} of the document data D₁, D₂ . . . D_{d} is substituted in linear classifier f(z) to determine the class of the document data D₁, D₂ . . . D_{d} based on this result.

f(Z)=w₀+w₁z₁+w₂z₂+ . . . +w_{d}z_{d} (1)

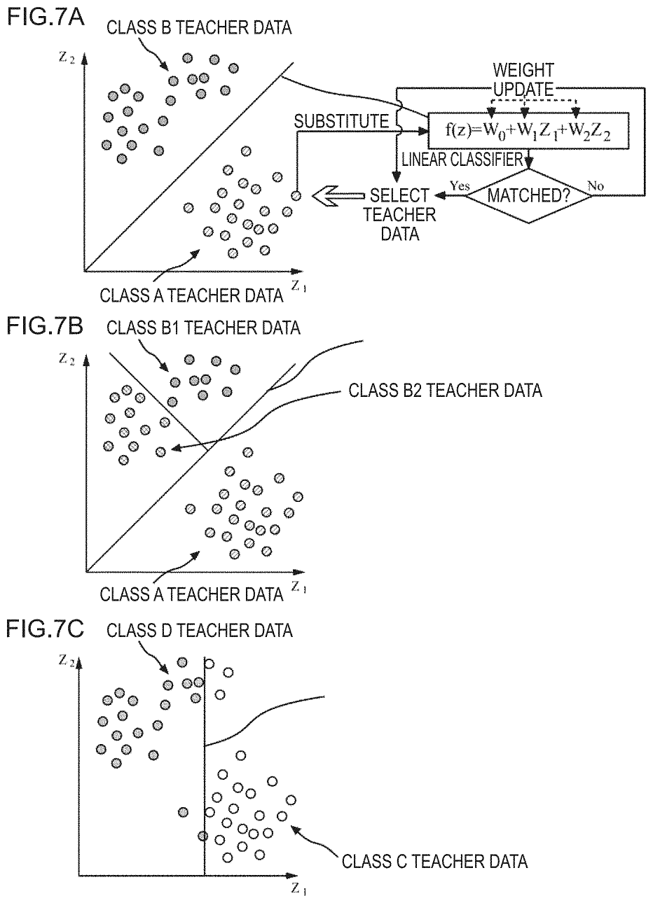

FIG. 7(A) is a diagram showing an example of classification when the number of classes is two, class A and class B, and the number of dimensions l′ is l′=2. In machine learning, the feature vector data group that is teacher data is prepared (in the example of FIG. 7(A), a feature vector data group associated with label information indicating that it is class A teacher data, and a feature vector data group associated with label information indicating that it is class B teacher data).

Next, the weighting coefficients of the linear classifier f(z) (in the example of FIG. 7(A), the two-dimensional linear classifier f(z)=w₀+w₁z₁+w₂z₂) are initialized. After that, the process in which the teacher data is substituted into the linear classifier f(z), and when the substituted result is different from the class indicated by the label information, the weighting coefficients are updated or when the substituted result matches the class indicated by the label information, another teacher data that has not been substituted into the linear classifier f(z) is selected is repeated to optimize the weighting coefficients.

After optimizing the weighting coefficients by machine learning, the CPU 22 substitutes the feature vector data z₁={z₁₁, z₁₂} of the document data D₁ into the linear classifier f(z) to determine the class to which the document data D₁ belongs, substitutes the feature vector data z₂={z₂₁, z₂₂} of the document data D₂ into the linear classifier f(z) to determine the class to which the document data D₂ belongs, . . . , and substitutes the feature vector data Z_{d}={z_{d1}, z_{d2}} of the document data D_{d} into the linear classifier f(z) to determine the class to which the document data Dₙ belongs, thereby classifying the document data D₁, D₂ . . . D_{d} into a plurality of classes.

The analysis result output process in step S400 in FIG. 6 is a process of outputting the analysis result of the search needs related to the search word to be evaluated based on the relationship between the classes. As shown in FIG. 6, in the analysis result output process, the CPU 22 transmits the HTML data of the analysis result screen to the user terminal 10 and displays the analysis result screen on the display of the user terminal 10. The analysis result screen has a top-ranking page identification. The frames Fₖ (k=1 to d) of the web page in the top-ranking page identification in FIG. 6 are color-coded so that the frames Fₖ belonging to the same class has the same color.

The evaluation axis setting process in step S450 is a process of setting the evaluation axis of the class identification process. As shown in FIGS. 7(B) and 7(C), the user replaces teacher data for the linear classifier f(z) with another teacher data (in the example of FIG. 7(B), teacher data of class A, class B1, and class B2, and in the example of FIG. 7(C), teacher data of class C and class D). When the user performs the operation to replace the teacher data, the CPU 22 optimizes the weighting coefficients of the linear classifier f(z) by machine learning using the replaced teacher data to determine the class to which document data D₁, D₂ . . . D_{d} belongs by the linear classifier f(z).

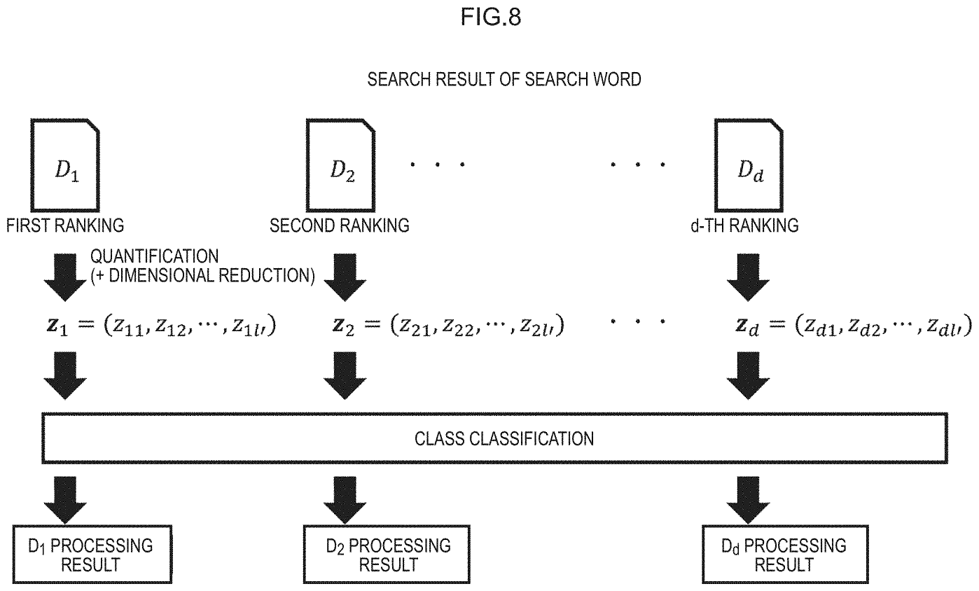

The above is the details of the embodiment. In the embodiment, as shown in FIG. 8, the CPU 22 converts the content and the structure of the d pieces of top ranking document data D₁, D₂ . . . D_{d} in the search result of one search word to be evaluated into the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}}, performs the classification process on the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}}, and classifies the document data D₁, D₂ . . . D_{d} into a plurality of subsets (classes). The CPU 22 outputs the analysis result of the property of search needs based on the relationship between a plurality of subsets which is the processing result of classification of the document data D₁, D₂ . . . D_{d}. The same effect as that of the first embodiment can be obtained by the embodiment as well.

### Third Embodiment

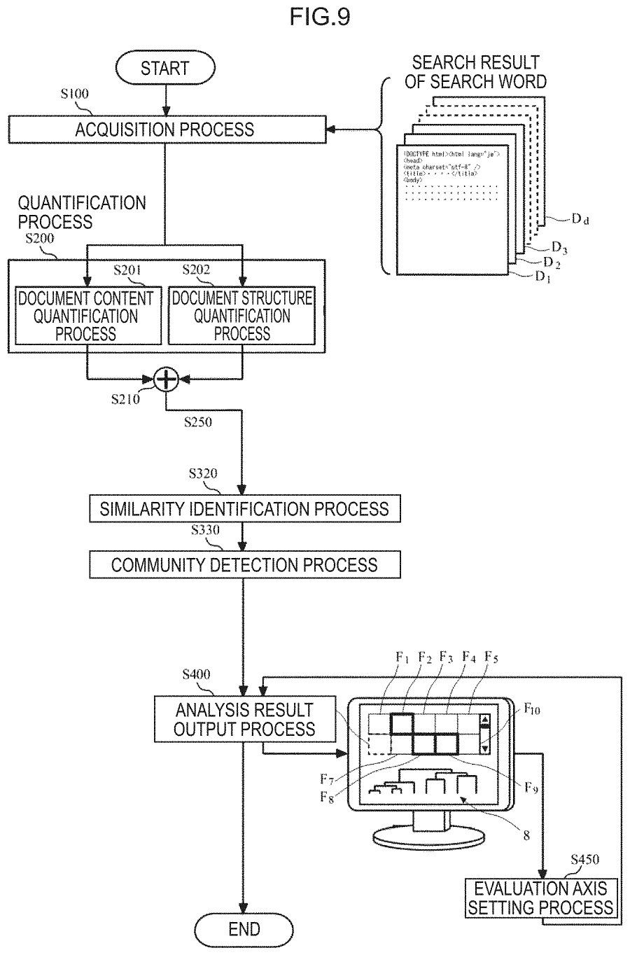

The third embodiment of the present invention will be described. FIG. 9 is a flowchart showing the flow of the evaluation method executed by the CPU 22 of the search needs evaluation apparatus 20 of the third embodiment according to the evaluation program 26. By executing the evaluation program 26, the CPU 22 functions as an acquisition means that performs an acquisition process (S100), a quantification means that performs a quantification process (S200), an addition means that performs an addition process (S210), a similarity identification means that performs a similarity identification process (S320), a community detection means that performs a community detection process (S330), an analysis result output means that performs an analysis result output process (S400), and an evaluation axis setting means that performs an evaluation axis setting process (S450).

Comparing FIG. 9 with FIG. 2 of the first embodiment, in FIG. 9, there is no dimension reduction process in step S330 of FIG. 2. In the embodiment, the similarity identification process in step S320 and the community detection process in step S330 are performed on the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}} of the document data D₁, D₂ . . . D_{d} as the processing target.

The similarity identification process in step S320 is a process of obtaining the similarity between document data Dₖ. In the similarity identification process, the correlation coefficient between the document data Dₖ for all combinations of the two document data Dₖ in the document data Dₖ (k=1 to d), and this correlation coefficient is set as the similarity between the document data Dₖ. The correlation coefficient may be a Pearson's correlation coefficient or a correlation coefficient in consideration of sparsity. Further, the variance-covariance matrix between the document data Dₖ, the Euclidean distance, the Minkowski distance, or the COS similarity may be set as the similarity between the document data Dₖ.

The community detection process in step S330 is a statistical identification process of classifying the document data D₁, D₂ . . . D_{d} into a plurality of subsets called communities. In the community detection process, the CPU 22 performs a process on the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}} of the document data D₁, D₂ . . . D_{d} according to the community detection algorithm to classify the document data D₁, D₂ . . . D_{d} into a plurality of communities.

The details of community detection will be explained. The community detection is a type of clustering. In community detection, each of the document data D₁, D₂ . . . D_{d} is set as a node, and a weighted undirected graph having an edge weighted by the similarity between the document data Dₖ is generated. Then, by repeating the calculation of the betweenness of each node in the weighted undirected graph and the removal of the edge with the maximum betweenness, the document data D₁, D₂ . . . D_{d} is classified into a plurality of communities having a hierarchical structure.

The analysis result output process in step S400 is a process of outputting the analysis result of the search needs related to the search word to be evaluated based on the relationship between the communities. As shown in FIG. 9, in the analysis result output process, the CPU 22 transmits the HTML data of the analysis result screen to the user terminal 10 and displays the analysis result screen on the display of the user terminal 10. The analysis result screen has a top-ranking page identification and a dendrogram 8. The frames Fₖ (k=1 to d) of the web page in the top-ranking page identification in FIG. 9 are color-coded so that the frames Fₖ belonging to the same community has the same color. Dendrogram 8 shows the hierarchical structure of the community obtained in the process of the community detection process.

The content of the evaluation axis setting process in step S450 is the same as that in the first embodiment.

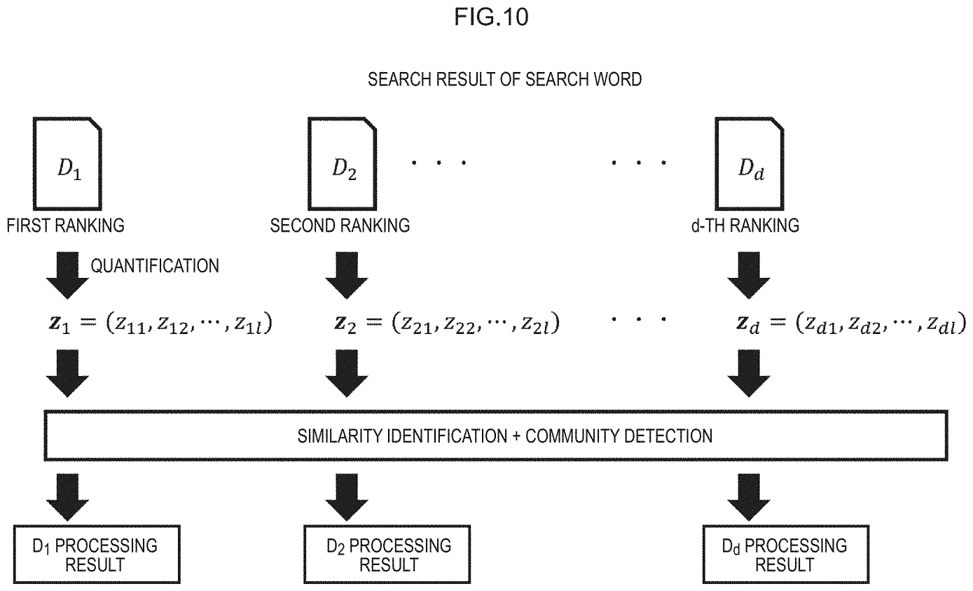

The above is the details of the embodiment. In the embodiment, as shown in FIG. 10, the CPU 22 converts the content and the structure of the d pieces of top ranking document data D₁, D₂ . . . D_{d} in the search results of one search word to be evaluated into the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}}, performs the process of similarity identification and community detection on the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}}, and classifies the document data D₁, D₂ . . . D_{d} into a plurality of subsets (communities). The CPU 22 outputs the analysis result of the property of search needs based on the relationship between a plurality of subsets which is the processing result of the community detection of the document data D₁, D₂ . . . D_{d}. The same effect as that of the first embodiment can be obtained by the embodiment as well.

### Fourth Embodiment

The fourth embodiment of the present embodiment will be described. The search needs evaluation service of the first to third embodiments described above is a service in which one search word is received from the user, the top d ranking web pages in the search result of the search word are classified by a predetermined statistical identification processing algorithm, and the set of a plurality of web pages obtained by this identification is presented as the analysis result. In the embodiment, a plurality of search words A, B, C . . . (for example, “AI intelligence”, “AI artificial”, “AI data” . . . etc.) that combines the nuclear word with various subwords are received from the user, the top d ranking document data groups for a plurality of the received search words A, B, C . . . are classified by a predetermined statistical identification processing algorithm, and a set of a plurality of document data obtained by this identification is presented as an analysis result of the property of search needs of the search word itself, which is the core word.

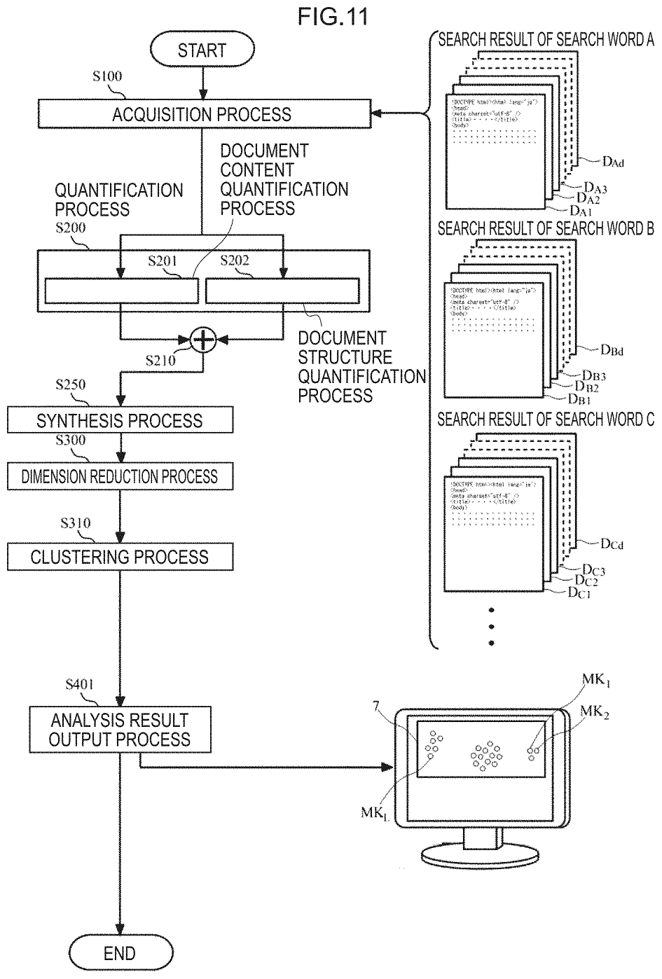

FIG. 11 is a flowchart showing the flow of the evaluation method executed by the CPU 22 of the search needs evaluation apparatus 20 of the fourth embodiment according to the evaluation program 26. By executing the evaluation program 26, the CPU 22 functions as an acquisition means that performs an acquisition process (S100), a quantification means that performs a quantification process (S200), an addition means that performs an addition process (S210), a combining means that performs a combining process (S250), a dimension reduction means that performs a dimension reduction process (S300), a identification means that performs a clustering process (S310), and an analysis result output means that performs an analysis result output process (S401).

Comparing FIG. 11 with FIG. 2 of the first embodiment, in FIG. 11, in the acquisition process in step S100, the CPU 22 receives a plurality of search words A, B, C . . . from user terminal 10, and acquires the document data D_{Ak} (k=1 to d), D_{Bk} (k=1 to d), D_{Ck} (k=1 to d) . . . of the top d ranking web pages in the search result for each search word for each of the plurality of search words A, B, C . . . . After this, the CPU 22 performs the quantification process in step S200 and the addition process in step S210 on the document data D_{Ak} (k=1 to d), D_{Bk} (k=1 to d), D_{Ck} (k=1 to d) . . . for each search word, and generates individually the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}}, which is the processing result of the top ranking documents of the search word A, the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}}, which is the processing result of the top ranking documents of the search word B, the feature vector data z_{C1}={z_{C11}, z_{C12} . . . z_{C1l}}, z_{C2}={z_{C21}, z_{C22} . . . z_{C2l}} . . . z_{Cd}={z_{Cd1}, _{Cd2} . . . z_{Cdl}} which is the processing result of the top ranking documents of the search word C . . . .

In FIG. 11, there is a combining process in step S250 between the addition process in step S210 and the dimension reduction process in step S300. In the combining process, the CPU 22 performs the predetermined statistical process on the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}} of the top ranking document of the search word A, the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}} of the top ranking document of the search word B, the feature vector data z_{C1}={z_{C11}, z_{C12} . . . z_{C1l}}, z_{C2}={z_{C21}, z_{C22} . . . z_{C2l}} . . . z_{Cd}={z_{Cd1}, _{Cd2} . . . z_{Cdl}} of the top ranking document of the search word C . . . , and generates individually the feature vector data z_{A}={z_{A1}, z_{A2} . . . z_{Al}} obtained by combining the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}} of the top ranking document of the search word A, the feature vector data z_{B}={z_{B1}, z_{B2} . . . z_{Bl}} obtained by combining the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}} of the top ranking document of the search word B, the feature vector data z_{C}={z_{C1}, z_{C2} . . . z_{Cl}} obtained by combining the top ranking document feature vector data z_{C1}={z_{C11}, z_{C12} . . . z_{C1l}}, z_{C2}={z_{C21}, z_{C22} . . . z_{C2l}} . . . z_{Cd}={z_{Cd1}, _{Cd2} . . . z_{Cdl}} of the search word C . . . .

After this, the CPU 22 performs the clustering process in step S310 and the analysis result output process in step S401 on the feature vector data z_{A}={z_{A1}, z_{A2} . . . z_{Al′}} of the search word A, the feature vector data z_{B}={z_{B1}, z_{B2} . . . z_{Bl′}} of the search word B, the feature vector data z_{C}={z_{C1}, z_{C2} . . . z_{Cl′}} of the search word C . . . as the processing target. That is, in the present embodiment, clustering is collectively performed on all documents instead of being performed for each search word.

In the analysis result output process in step S401 in FIG. 11, the analysis result screen is displayed on the display of the user terminal 10. The analysis result screen has a mapping image 7. In the mapping image 7, marks MK₁, MK₂ . . . MK_{L} indicating the positions of a plurality of search words A, B, C . . . are disposed in a two-dimensional plane. The mapping image 7 is generated based on the processing result in steps S250, S300, and S310.

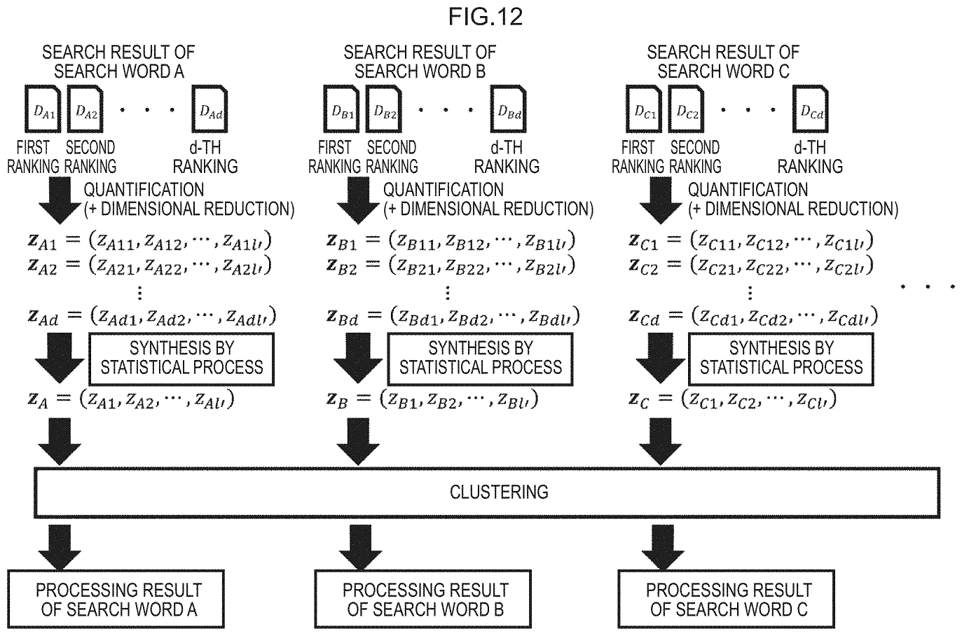

The above is the details of the embodiment. In the embodiment, as shown in FIG. 12, the CPU 22 acquires the d pieces of top ranking document data D_{Ak} (k=1 to d), D_{Bk} (k=1 to d), D_{Ck} (k=1 to d) . . . in the search result for each search word for each of the plurality of search words A, B, C . . . to be evaluated, converts the content and the structure of the document data D_{Ak} (k=1 to d), D_{Bk} (k=1 to d), D_{Ck} (k=1 to d) . . . in the search result for each search word into the multidimensional feature vector data z_{A1}, z_{A2} . . . z_{Ad}, z_{B1}, z_{B2} . . . z_{Bd}, z_{C1}, z_{C2} . . . z_{Cd} . . . , and performs the predetermined statistical process on the feature vector data for each document to combine the feature vector data for each search word. After that, the clustering process is performed on the combined feature vector data z_{A}, z_{B}, z_{C} . . . , and the search word A, the search word B, the search word C . . . are classified into a plurality of subsets (clusters) to output the mapping image 7 which is the analysis result of the property of search needs based on the relationship between a plurality of subsets that is the processing result of clustering. Therefore, according to the present embodiment, by referring to the mapping image 7, it is possible to intuitively grasp how close the property of search needs related to various search words including common words is. Therefore, even in the embodiment, it is possible to efficiently analyze how much different needs are mixed in the words of the search word and what the property of needs is.

### Fifth Embodiment

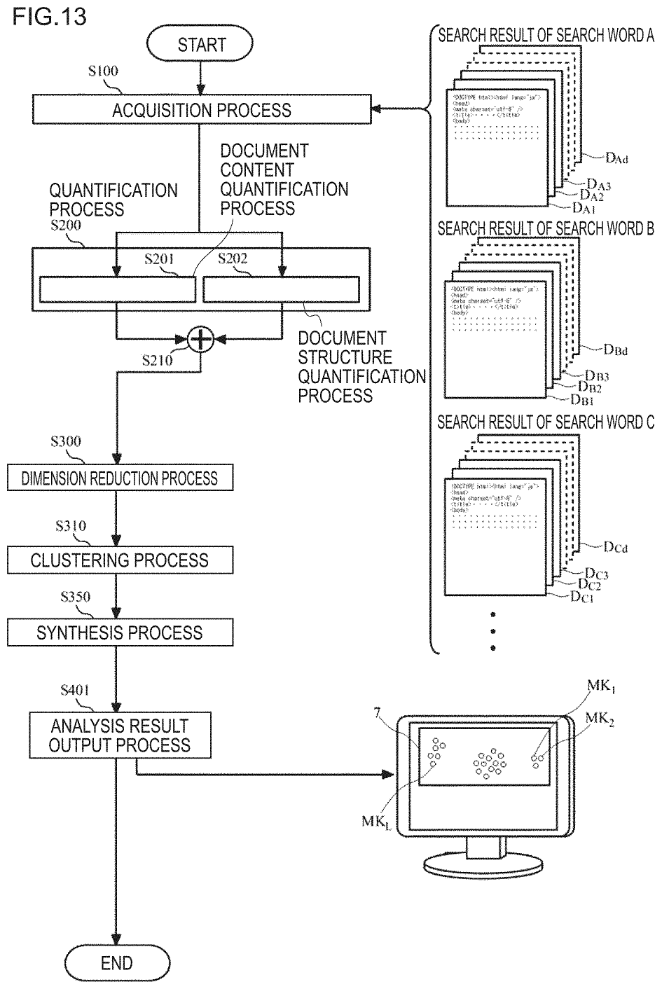

The fifth embodiment of the present invention will be described. FIG. 13 is a flowchart showing the flow of the evaluation method executed by the CPU 22 of the search needs evaluation apparatus 20 of the fifth embodiment according to the evaluation program 26. By executing the evaluation program 26, the CPU 22 functions as an acquisition means that performs an acquisition process (S100), a quantification means that performs a quantification process (S200), an addition means that performs an addition process (S210), a dimension reduction means that performs a dimension reduction process (S300), a identification means that performs a clustering process (S310), a combining means that performs a combining process (S350), and an analysis result output means that performs an analysis result output process (S401).

Comparing FIG. 13 with FIG. 11 of the fourth embodiment, in FIG. 13, there is no combining process in step S250 of FIG. 11, and there is a combining process in step S350 between steps S310 and S401. In the embodiment, the CPU 22 performs the dimension reduction process in step S300 and clustering process in step S310 on the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}} of the top ranking document of the search word A, the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}} of the top ranking document of the search word B, the feature vector data z_{C1}={z_{C11}, z_{C12} . . . z_{C1l}}, z_{C2}={z_{C21}, z_{C22} . . . z_{C2l}} . . . z_{Cd}={z_{Cd1}, z_{Cd2} . . . z_{Cdl}} of the top ranking document of the search word C . . . as the processing target to acquire the processing result of the clustering process of the document data D_{Ak} (k=1 to d), D_{Bk} (k=1 to d), D_{Ck} (k=1 to d) . . . . In the combining process in step S350, the CPU 22 performs a predetermined statistical process on the processing result of clustering for each document to combine the processing result of clustering for each search word.

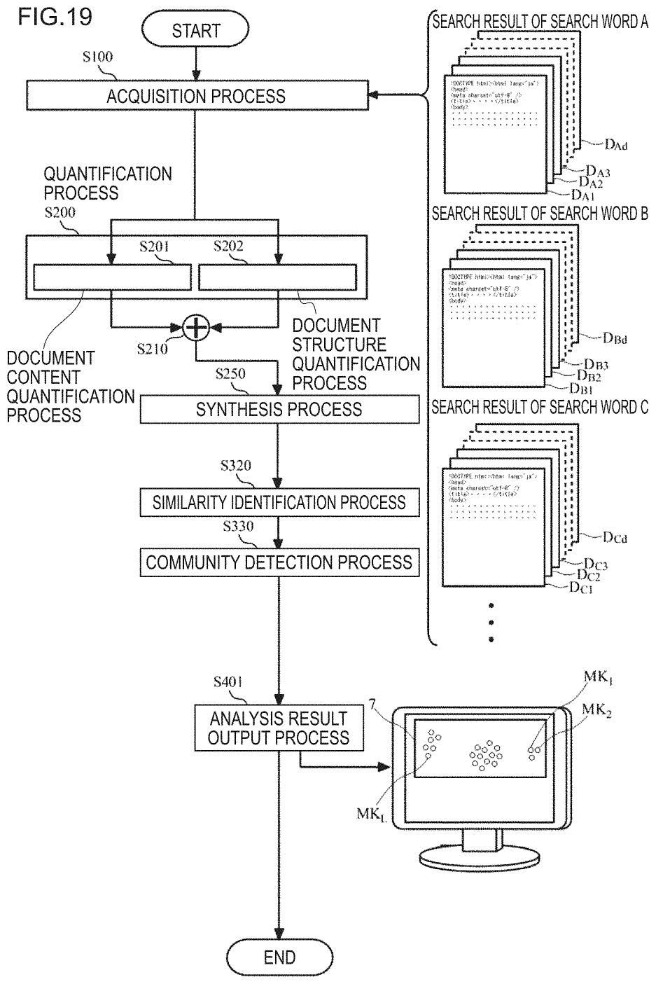

In the analysis result output process in step S401 in FIG. 13, the analysis result screen is displayed on the display of the user terminal 10. The mapping image 7 of the analysis result screen of FIG. 19 is generated based on the processing result in steps S300, S310, and S350.

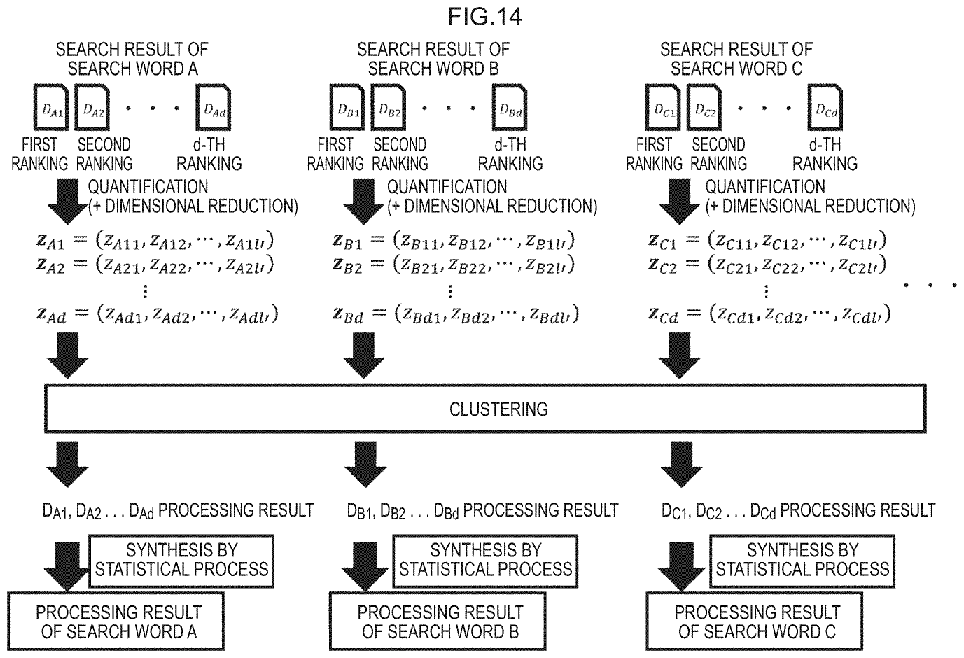

The above is the details of the configuration of the present embodiment. In the embodiment, as shown in FIG. 14, the CPU 22 acquires the d pieces of top ranking document data D_{Ak} (k=1 to d), D_{Bk} (k=1 to d), D_{Ck} (k=1 to d) . . . in the search result for each search word for the plurality of search words A, B, C . . . to be evaluated, converts the content and the structure of the document data D_{Ak} (k=1 to d), D_{Bk} (k=1 to d), D_{Ck} (k=1 to d) . . . in the search result for each search word into the multidimensional feature vector data z_{A1}, z_{A2} . . . z_{Ad}, z_{B1}, z_{B2} . . . z_{Bd}, z_{C1}, z_{C2} . . . z_{Cd} . . . , and performs a process on the feature vector data for each document according to the clustering algorithm to classify the plurality of document data into a plurality of subsets. After that, the predetermined statistical process is performed on the processing result of clustering, the processing result of clustering for each search word is combined, and the analysis result of the property of search needs is outputted based on the relationship between the combined subsets. The same effect as that of the fourth embodiment can be obtained by the embodiment as well.

### Sixth Embodiment

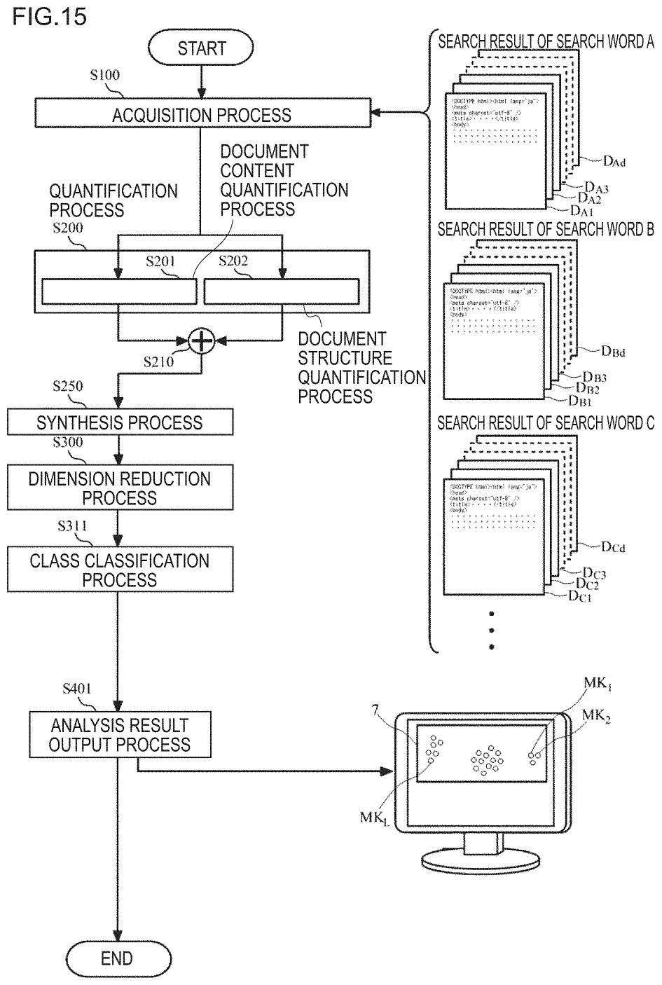

The sixth embodiment of the present embodiment will be described. FIG. 15 is a flowchart showing the flow of the evaluation method executed by the CPU 22 of the search needs evaluation apparatus 20 of the sixth embodiment according to the evaluation program 26. By executing the evaluation program 26, the CPU 22 functions as an acquisition means that performs an acquisition process (S100), a quantification means that performs a quantification process (S200), an addition means that performs an addition process (S210), a combining means that performs a combining process (S250), a dimension reduction means that performs a dimension reduction process (S300), a identification means that performs classification process (S311), and an analysis result output means that performs an analysis result output process (S401).

Comparing FIG. 15 with FIG. 6 of the second embodiment, in FIG. 15, in the acquisition process in step S100, the CPU 22 receives a plurality of search words A, B, C . . . , from user terminal 10 and acquires the document data D_{Ak} (k=1 to d), D_{Bk} (k=1 to d), D_{Ck} (k=1 to d) . . . of the top d ranking web pages in the search result for each search word for each of the plurality of search words A, B, C . . . . After this, the CPU 22 performs the quantification process in step S200 and the addition process in step S210 on the document data D_{Ak} (k=1 to d), D_{Bk} (k=1 to d), D_{Ck} (k=1 to d) . . . for each search word, and generates individually the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}}, which is the processing result of the top ranking documents of the search word A, the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}}, which is the processing result of the top ranking documents of the search word B, the feature vector data z_{C1}={z_{C11}, z_{C12} . . . z_{C1l}}, z_{C2}={z_{C21}, z_{C22} . . . z_{C2l}} . . . z_{Cd}={z_{Cd1}, z_{Cd2} . . . z_{Cdl}} which is the processing result of the top ranking documents of the search word C . . . .

In FIG. 15, there is a combining process in step S250 between the addition process in step S210 and the dimension reduction process in step S300. In the combining process, the CPU 22 performs the predetermined statistical process on the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}} of the top ranking document of the search word A, the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}} of the top ranking document of the search word B, the feature vector data z_{C1}={z_{C11}, z_{C12} . . . z_{C1l}}, z_{C2}={z_{C21}, z_{C22} . . . z_{C2l}} . . . z_{Cd}={z_{Cd1}, z_{Cd2} . . . z_{Cdl}} of the top ranking document of the search word C . . . , and generates individually the feature vector data z_{A}={z_{A1}, z_{A2} . . . z_{Al}} of the search word A obtained by combining the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}} of the top ranking document of the search word A, the feature vector data z_{B}={z_{B1}, z_{B2} . . . z_{Bl}} of search word B obtained by combining the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}} of the top ranking document of the search word B, the feature vector data z_{C}={z_{C1}, z_{C2} . . . z_{Cl}} of search word C obtained by combining the feature vector data z_{C1}={z_{C11}, z_{C12} . . . z_{C1l}}, z_{C2}={z_{C21}, z_{C22} . . . z_{C2l}} . . . z_{Cd}={z_{Cd1}, z_{Cd2} . . . z_{Cdl}} of the top ranking document of the search word C . . . .

After this, the CPU 22 performs the classification process in step S311 and the analysis result output process in step S401 on the feature vector data z_{A}={z_{A1}, z_{A2} . . . z_{Al′}} of the search word A, the feature vector data z_{B}={z_{B1}, z_{B2} . . . z_{Bl′}} of the search word B, the feature vector data z_{C}={z_{C1}, z_{C2} . . . z_{Cl′}} of the search word C . . . as the processing target. That is, in the present embodiment, classification is collectively performed on all documents instead of being performed for each search word.

In the analysis result output process in step S401 in FIG. 15, the analysis result screen is displayed on the display of the user terminal 10. The mapping image 7 of the analysis result screen of FIG. 15 is generated based on the processing result in steps S250, S300, and S311.

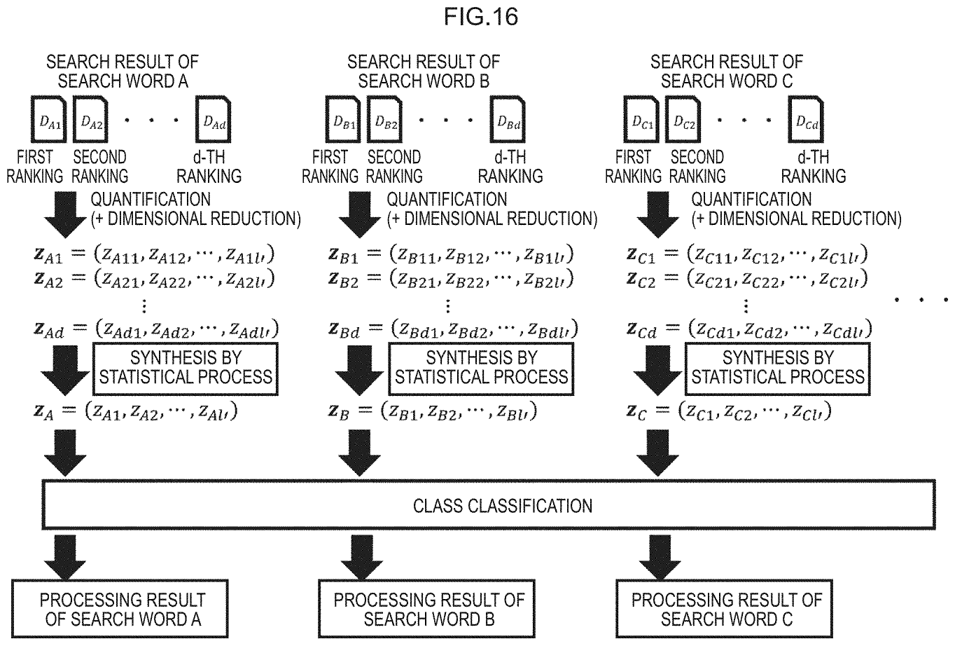

The above is the details of the embodiment. In the embodiment, as shown in FIG. 16, the CPU 22 acquires the d pieces of top ranking document data D_{Ak} (k=1 to d), D_{Bk} (k=1 to d), D_{Ck} (k=1 to d) . . . in the search result for each search word for each of the plurality of search words A, B, C . . . to be evaluated, converts the content and the structure of the document data D_{Ak} (k=1 to d), D_{Bk} (k=1 to d), D_{Ck} (k=1 to d) . . . in the search result for each search word into the multidimensional feature vector data z_{A1}, z_{A2} . . . z_{Ad}, z_{B1}, z_{B2} . . . z_{Bd}, z_{C1}, z_{C2} . . . z_{Cd} . . . , and performs the predetermined statistical process on the feature vector data for each document to combine the feature vector data for each search word. After that, the classification process is performed on the combined feature vector data z_{A}, z_{B}, z_{C} . . . , and the search words A, B, C . . . are classified into a plurality of subsets (classes) to output the analysis result of the property of search needs based on the relationship between a plurality of subsets that is the processing result of classification. The same effect as that of the fourth embodiment can be obtained by the embodiment as well.

### Seventh Embodiment

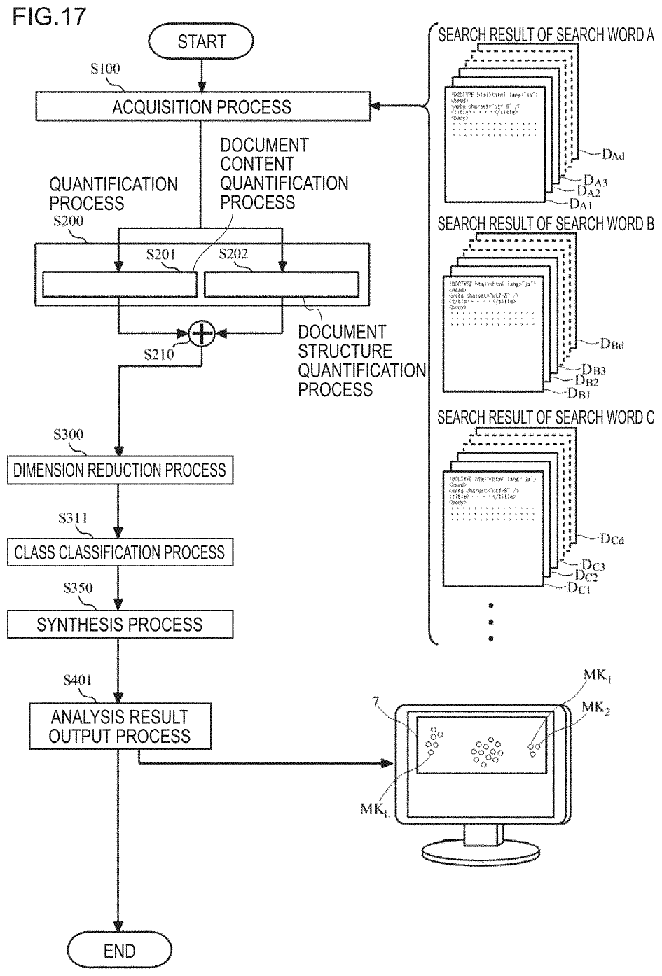

The seventh embodiment of the present invention will be described. FIG. 17 is a flowchart showing the flow of the evaluation method executed by the CPU 22 of the search needs evaluation apparatus 20 of the seventh embodiment according to the evaluation program 26. By executing the evaluation program 26, the CPU 22 functions as an acquisition means that performs an acquisition process (S100), a quantification means that performs a quantification process (S200), an addition means that performs an addition process (S210), a dimension reduction means that performs a dimension reduction process (S300), a identification means that performs classification process (S311), a combining means that performs a combining process (S350), and an analysis result output means that performs an analysis result output process (S401).

Comparing FIG. 17 with FIG. 15 of the sixth embodiment, in FIG. 17, there is no combining process in step S250 of FIG. 15, and there is a combining process in step S350 between steps S311 and S401. In the embodiment, the CPU 22 performs the dimension reduction process in step S300 and the class identification process in step S311 on the feature vector data z_{A1}={z_{A11}, z_{A12} . . . z_{A1l}}, Z_{A2}={Z_{A21}, Z_{A22} . . . Z_{A2l}} . . . Z_{Ad}={Z_{Ad1}, Z_{Ad2} . . . Z_{Adl}} of the top ranking document of the search word A, the feature vector data z_{B1}={z_{B11}, z_{B12} . . . z_{B1l}}, z_{B2}={z_{B21}, z_{B22} . . . z_{B2l}} . . . z_{Bd}={Z_{Bd1}, z_{Bd2} . . . z_{Bdl}} of the top ranking document of the search word B, the feature vector data z_{C1}={z_{CD1}, z_{CD2} . . . z_{C1}}, z_{C2}={z_{C21}, z_{C22} . . . z_{C2l}} . . . z_{Cd}={z_{Cd1}, z_{Cd2} . . . z_{Cdl}} of the top ranking document of the search word C . . . as the processing target to acquire the processing result of the classification process of the document data D_{Ak} (k=1 to d), D_{Bk} (k=1 to d), D_{Ck} (k=1 to d) . . . . In the combining process in step S350, the CPU 22 performs a predetermined statistical process on the processing result of the classification for each document to combine the processing result of the classification for each search word.

In the analysis result output process in step S401 in FIG. 17, the analysis result screen is displayed on the display of the user terminal 10. The mapping image 7 of the analysis result screen of FIG. 17 is generated based on the processing result in steps S300, S311, and S350.

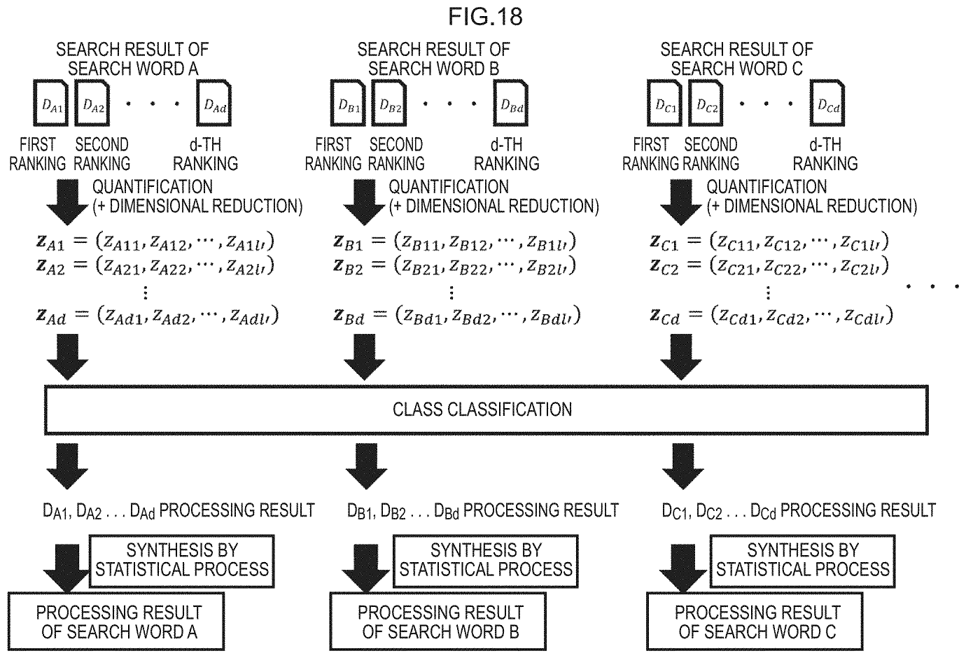

The above is the details of the configuration of the present embodiment. In the embodiment, as shown in FIG. 18, the CPU 22 acquires the d pieces of top ranking document data D_{Ak} (k=1 to d), D_{Bk} (k=1 to d), D_{Ck} (k=1 to d) . . . in the search results for each search word for each of the plurality of search words A, B, C . . . to be evaluated, converts the content and the structure of the document data D_{Ak} (k=1 to d), D_{Bk} (k=1 to d), D_{Ck} (k=1 to d) . . . in the search results for each search word into the multidimensional feature vector data z_{A1}, Z_{A2} . . . z_{Ad}, z_{B1}, z_{B2} . . . z_{Bd}, z_{C1}, z_{C2} . . . z_{Cd} . . . , and performs a process on the feature vector data for each document according to the classification algorithm to classify a plurality of document data in the search result for each search word into a plurality of subsets. After that, the predetermined statistical process is performed on the processing result of classification, the processing result of classification for each search word is combined, and the analysis result of the property of search needs is outputted based on the relationship between the combined subsets. The same effect as that of the fourth embodiment can be obtained by the embodiment as well.

### Eighth Embodiment

The eighth embodiment of the present embodiment will be described. FIG. 19 is a flowchart showing the flow of the evaluation method executed by the CPU 22 of the search needs evaluation apparatus 20 of the eighth embodiment according to the evaluation program 26. By executing the evaluation program 26, the CPU 22 functions as an acquisition means that performs an acquisition process (S100), a quantification means that performs a quantification process (S200), an addition means that performs an addition process (S210), a combining means that performs a combining process (S250), a similarity identification means that performs a similarity identification process (S320), a community detection means that performs a community detection process (S330), and an analysis result output means that performs an analysis result output process (S401).

Comparing FIG. 19 with FIG. 9 of the third embodiment, in FIG. 19, in FIG. 19, in the acquisition process in step S100, the CPU 22 receives a plurality of search words A, B, C . . . from user terminal 10, and acquire the document data D_{Ak} (k=1 to d), D_{Bk} (k=1 to d), D_{Ck} (k=1 to d) . . . of the top d ranking web pages in the search result for each search word for each of the plurality of search words A, B, C . . . . After this, the CPU 22 performs the quantification process in step S200 and the addition process in step S210 on the document data D_{Ak} (k=1 to d), D_{Bk} (k=1 to d), D_{Ck} (k=1 to d) . . . for each search word, and generates individually the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}}, which is the processing result of the top ranking documents of the search word A, the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}}, which is the processing result of the top ranking documents of the search word B, the feature vector data z_{C1}={z_{C11}, z_{C12} . . . z_{C1l}}, z_{C2}={z_{C21}, z_{C22} . . . z_{C2l}} . . . z_{Cd}={z_{Cd1}, z_{Cd2} . . . z_{Cdl}} which is the processing result of the top ranking documents of the search word C . . . .

In FIG. 19, there is a combining process in step S250 between the addition process in step S210 and the dimension reduction process in step S300. In the combining process, the CPU 22 performs the predetermined statistical process on the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}} of the top ranking document of the search word A, the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}} of the top ranking document of the search word B, the feature vector data z_{C1}={z_{C11}, z_{C12} . . . z_{C1l}}, z_{C2}={z_{C21}, z_{C22} . . . z_{C2l}} . . . z_{Cd}={z_{Cd1}, z_{Cd2} . . . z_{Cdl}} of the top ranking document of the search word C . . . , and generates individually the feature vector data z_{A}={z_{A1}, z_{A2} . . . z_{Al}} of the search word A obtained by combining the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}} of the top ranking document of the search word A, the feature vector data z_{B}={z_{B1}, z_{B2} . . . z_{Bl}} of search word B obtained by combining the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}} of the top ranking document of the search word B, the feature vector data z_{C}={z_{C1}, z_{C2} . . . z_{Cl}} of search word C obtained by combining the feature vector data z_{C1}={z_{C11}, z_{C12} . . . z_{C1l}}, z_{C2}={z_{C21}, z_{C22} . . . z_{C2l}} . . . z_{Cd}={z_{Cd1}, z_{Cd2} . . . z_{Cdl}} of the top ranking document of the search word C . . . .

After this, the CPU 22 performs the similarity identification process in step S320, the community detection process in step S330, and the analysis result output process in step S401 on the feature vector data z_{A}={z_{A1}, z_{A2} . . . z_{Al}} of the search word A, the feature vector data z_{B}={z_{B1}, z_{B2} . . . z_{Bl}} of the search word B, the feature vector data z_{C}={z_{C1}, z_{C2} . . . z_{Cl}} of the search word C . . . as the processing target. That is, in the present embodiment, similarity identification and community detection are collectively performed on all the documents instead of being performed for each search word.

In the analysis result output process in step S401 in FIG. 19, the analysis result screen is displayed on the display of the user terminal 10. The mapping image 7 of the analysis result screen of FIG. 19 is generated based on the processing result in steps S250, S320, and S330.

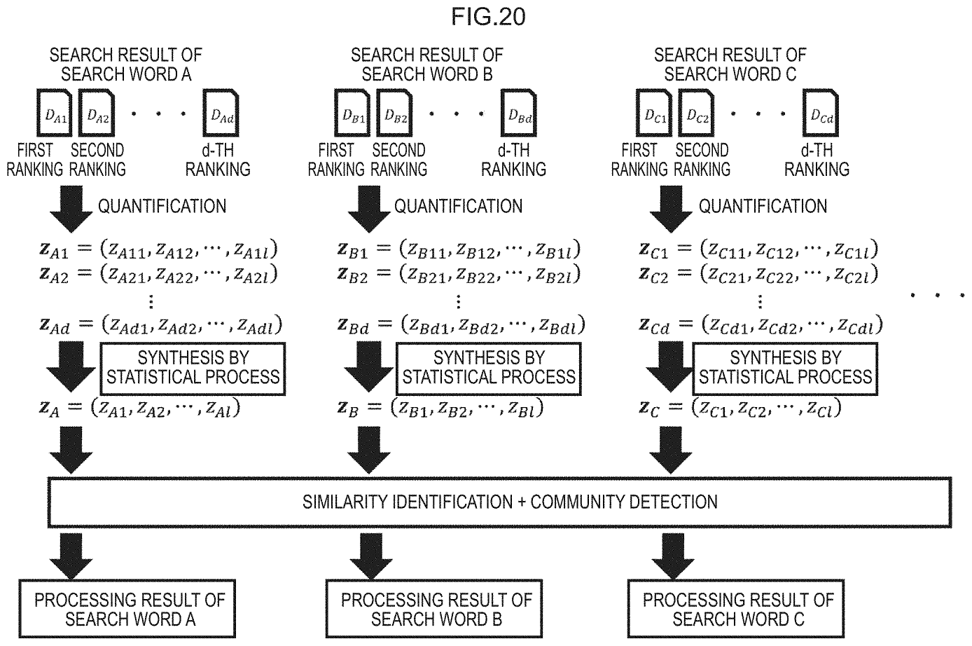

The above is the details of the embodiment. In the embodiment, as shown in FIG. 20, the CPU 22 acquires the d pieces of top ranking document data D_{Ak} (k=1 to d), D_{Bk} (k=1 to d), D_{Ck} (k=1 to d) . . . in the search result for each search word for each of the plurality of search words A, B, C . . . to be evaluated, converts the content and the structure of the document data D_{Ak} (k=1 to d), D_{Bk} (k=1 to d), D_{Ck} (k=1 to d) . . . in the search result for each search word into the multidimensional feature vector data z_{A1}, z_{A2} . . . z_{Ad}, z_{B1}, z_{B2} . . . z_{Bd}, z_{C1}, z_{C2} . . . z_{Cd} . . . , and performs the predetermined statistical process on the feature vector data for each document to combine the feature vector data for each search word. After that, the processes of similarity identification and community detection are performed on the combined feature vector data z_{A}, z_{B}, z_{C} . . . , and the search words A, B, C . . . are classified into a plurality of communities to output the analysis result of the property of search needs based on the relationship between a plurality of communities that is the processing result of community detection. The same effect as that of the fourth embodiment can be obtained by the embodiment as well.

### Ninth Embodiment

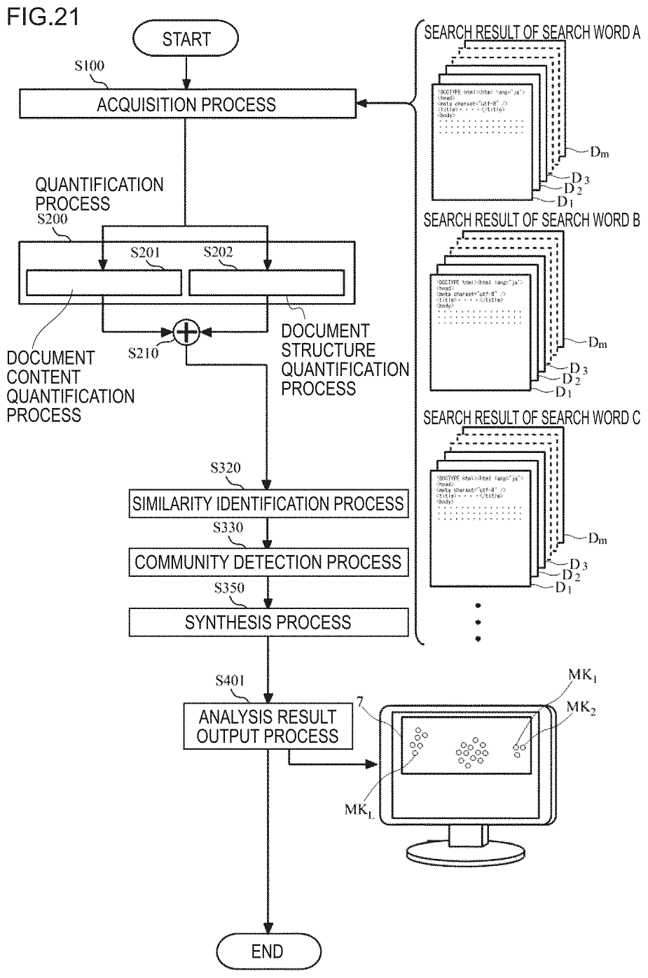

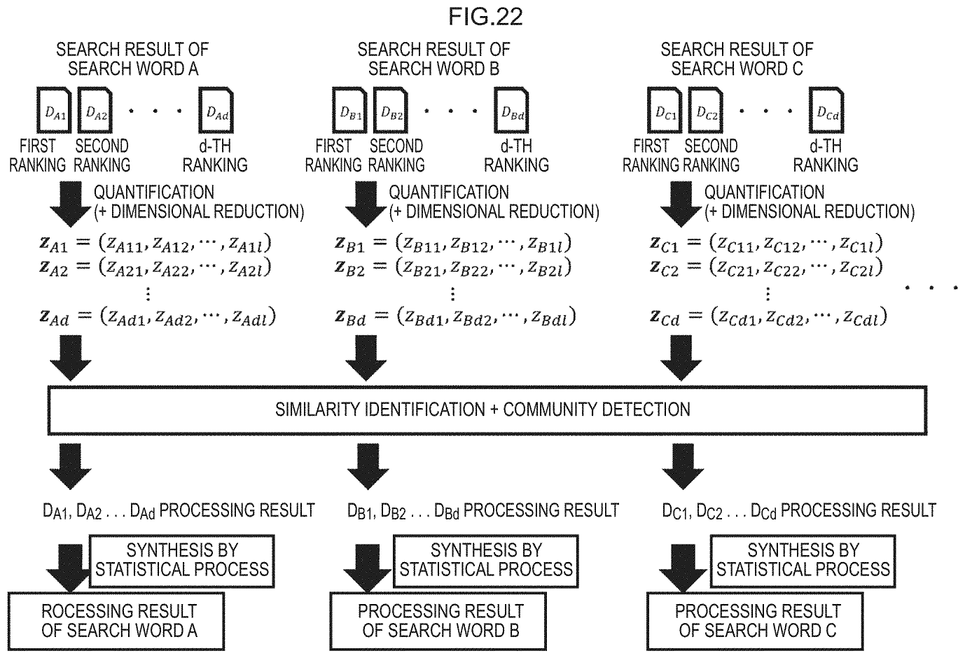

The ninth embodiment of the present invention will be described. FIG. 21 is a flowchart showing the flow of the evaluation method executed by the CPU 22 of the search needs evaluation apparatus 20 of the ninth embodiment according to the evaluation program 26. By executing the evaluation program 26, the CPU 22 functions as an acquisition means that performs an acquisition process (S100), a quantification means that performs a quantification process (S200), an addition means that performs an addition process (S210), a similarity identification means that performs a similarity identification process (S320), a community detection means that performs a community detection process (S330), a combining means that performs a combining process (S350), and an analysis result output means that performs an analysis result output process (S401).

Comparing FIG. 21 with FIG. 19 of the eighth embodiment, in FIG. 21, there is no combining process in step S250 of FIG. 19, and there is a combining process in step S350 between steps S330 and S401. In the embodiment, the CPU 22 performs the similarity identification process in step S320 and the community detection process in step S330 on the feature vector data z_{A1}={z_{A11}, z_{A12} . . . z_{A1l}}, z_{A2}={z_{A21}, z_{A22} . . . z_{A2l}} . . . z_{Ad}={z_{Ad1}, z_{Ad2} . . . z_{Adl}} of the top ranking document of the search word A, the feature vector data z_{B1}={z_{B11}, z_{B12} . . . z_{B1l}}, z_{B2}={z_{B21}, z_{B22} . . . z_{B2l}} . . . z_{Bd}={z_{Bd1}, z_{Bd2} . . . z_{Bdl}} of the top ranking document of the search word B, the feature vector data z_{C1}={z_{C11}, z_{C12} . . . z_{C1l}}, z_{C2}={z_{C21}, z_{C22} . . . z_{C2l}} . . . z_{Cd}={z_{Cd1}, z_{Cd2} . . . z_{Cdl}} of the top ranking document of the search word C . . . as the processing target to acquire the processing result of the community detection process of the document data D_{Ak} (k=1 to d), D_{Bk} (k=1 to d), D_{Ck} (k=1 to d) . . . . In the combining process in step S350, the CPU 22 performs a predetermined statistical process on the processing result of community detection for each document to combine the processing result of community detection for each search word.

In the analysis result output process in step S401 in FIG. 21, the analysis result screen is displayed on the display of the user terminal 10. The mapping image 7 of the analysis result screen of FIG. 21 is generated based on the processing result in steps S320, S330, and S350.

The above is the details of the configuration of the present embodiment. In the embodiment, as shown in FIG. 14, the CPU 22 acquires the d pieces of top ranking document data D_{Ak} (k=1 to d), D_{Bk} (k=1 to d), D_{Ck} (k=1 to d) . . . in the search results for each search word for the plurality of search words A, B, C . . . to be evaluated, converts the content and the structure of the document data D_{Ak} (k=1 to d), D_{Bk} (k=1 to d), D_{Ck} (k=1 to d) . . . in the search result for each search word into the multidimensional feature vector data z_{A1}, z_{A2} . . . z_{Ad}, z_{B1}, z_{B2} . . . z_{Bd}, z_{C1}, z_{C2} . . . z_{Cd} . . . , and performs the similarity identification process and the community detection process on the feature vector data for each document to classify the plurality of document data into a plurality of communities. After that, the predetermined statistical process is performed on the processing result, the processing result for each search word is combined, and the analysis result of the property of search needs is outputted based on the relationship between the combined communities. The same effect as that of the fourth embodiment can be obtained by the embodiment as well.

### Tenth Embodiment

In the tenth embodiment, a display example of the analysis result using the weighted undirected graph will be specifically described.

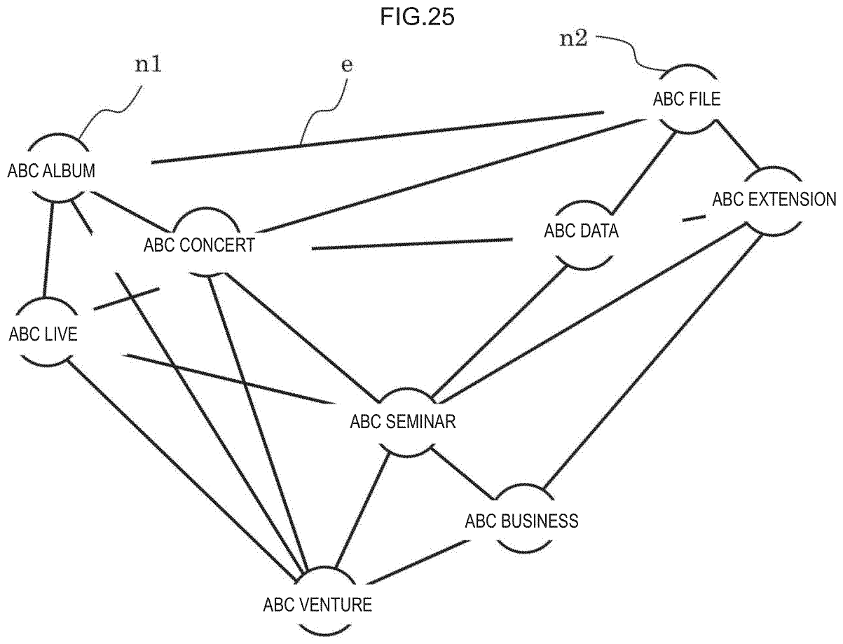

FIG. 25 is a diagram showing the mapping image 7 of FIG. 11 more specifically. This mapping image 7 exemplifies the analysis result regarding the search word including the common word “ABC”. It is assumed that there is a technical term “ABC”, an electronic file extension “ABC”, and a singer “ABC”.

The mapping image 7 of FIG. 25 shows the analysis result as a graph (undirected graph) including nodes (for example, symbols n1 and n2) and edges (for example, symbol e) connecting the nodes. Each search word is associated with the node. The edge length corresponds to the similarity of the search needs between the search word associated with the node at one end and the search word associated with the node at the other end. Specifically, the higher the similarity between one search word and another search word, the shorter the edge. Therefore, the nodes associated with the search words having a high similarity in the search needs are aligned close to each other. When the similarity between the two search words is lower than the predetermined value, the edge between the nodes associated with both search words may be omitted.

Here, the similarity may be, for example, the one described above in the eighth embodiment, or may be calculated by another method based on the search result for the search word.

By displaying in this way, highly relevant search words become clear at a glance. According to FIG. 25, it can be seen that “ABC Seminar”, “ABC Business”, and “ABC Venture” are highly relevant, “ABC Live”, “ABC Album”, and “ABC Concert” are highly relevant, and “ABC extension”, “ABC data”, and “ABC file” are highly relevant. This is because the Web sites visited with the search word “ABC Seminar” are often visited with the search word “ABC Business” or “ABC Venture”, but are rarely visited with the search word “ABC Live” or “ABC Data”.

For example, when it is desired to create a Web page about a technology called “ABC”, Web pages should be created considering that the user is visited with search words such as “ABC seminar”, “ABC business”, and “ABC venture”.

Further, in the undirected graph shown in FIG. 25, the user may be able to move the node. To move a node, for example, a method of clicking a desired node with a mouse or tapping a desired node with a touch panel to select a node and dragging the selected node to any other places can be considered.

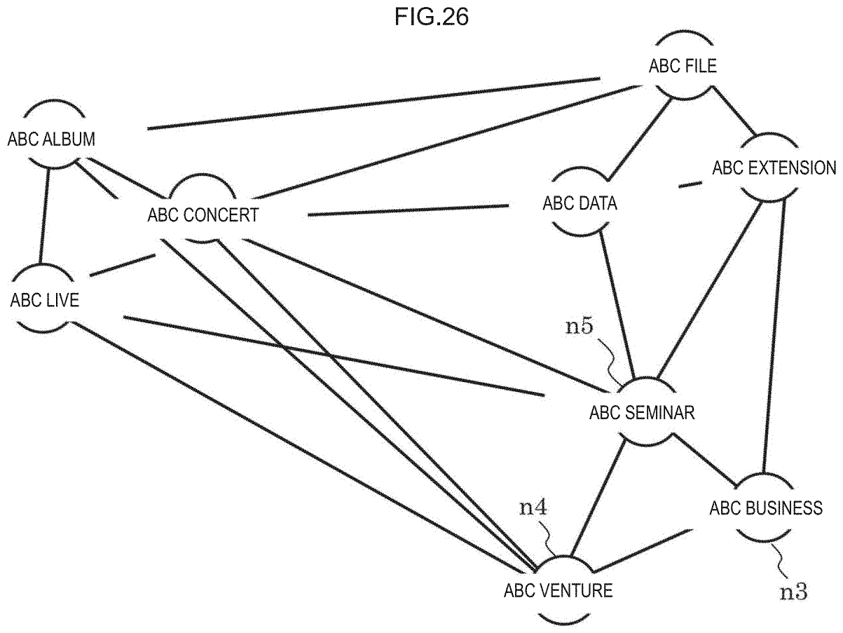

FIG. 26 is a diagram showing a state in which a node n3 associated with the “ABC business” in FIG. 25 is moved.

As the node n3 is moved by user operation, other nodes (nodes n4 and n5 in FIG. 26) that are at least close to the node n3 (similarity is equal to or higher than a predetermined value) are automatically moved so that they are attracted to the node n3. At this time, the length of the edge is determined by a mechanical model such as a spring or a Coulomb force. Specifically, when the edge is pulled by the movement of the node, the edge is stretched, the pulling force is strengthened by the stretched force, and the edge converges to a shortness in which the force can be balanced over time.

Although only a small number of nodes (search words) are drawn in FIGS. 25 and 26, a large number of nodes (search words) are actually displayed. Therefore, in some cases, nodes may be concentrated in one place. In this case, by moving the node associated with the search word of interest to any location, the search word having a high similarity can be displayed more easily.

FIG. 27 is a diagram showing the mapping image 7 in which search words are classified into clusters and nodes are displayed in a display mode according to the classified clusters. For example, the method described above in the fourth embodiment may be applied to the clustering, or another method based on the search result for the search word may be applied. The search word itself is omitted in FIG. 27 and the like.

The figure shows an example in which each search word is classified into one of two clusters A, B, and C. Nodes associated with search words classified in cluster A are displayed in black, nodes associated with search words classified in cluster B are displayed in white, and nodes associated with search words classified in cluster C are displayed with diagonal lines. In addition, color coding may be performed according to the cluster.

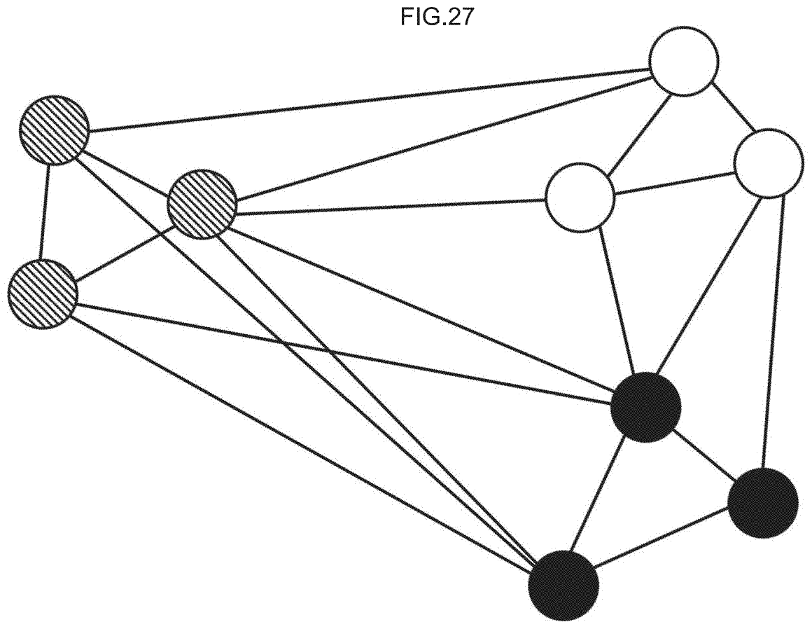

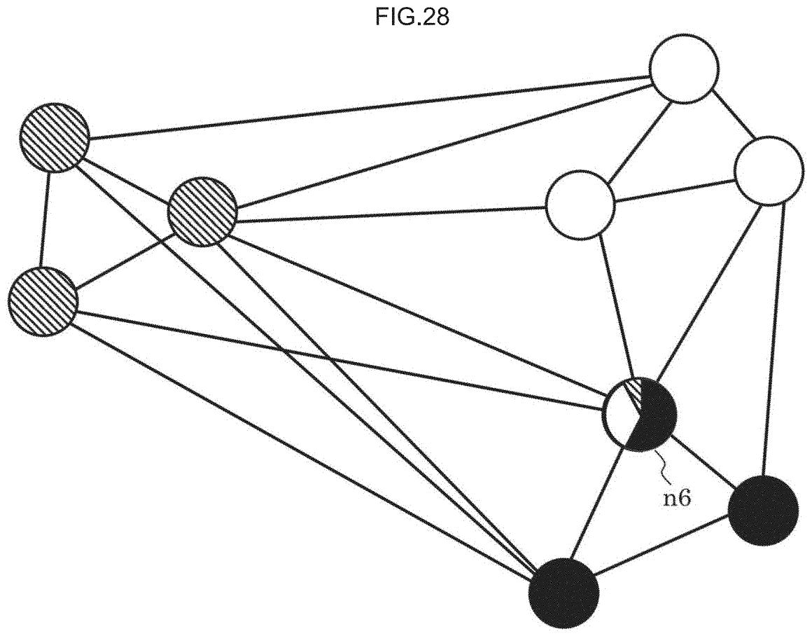

FIG. 28 is a diagram showing the mapping image 7 in the case where the search word is not determined to be classified into one cluster but can be classified into a plurality of clusters. For each search word, how close the search word is to which cluster (how much it has the property of which cluster) is calculated. In the example of FIG. 28, a certain search word is determined to be 60% for cluster A, 30% for cluster B, and 10% for cluster C. In this case, the node n6 to which the search word is associated is displayed with 60% black, 30% white, and 10% diagonal lines, as in the pie chart.

Further, as described in the first embodiment, the granularity of the identification can be made finer or coarser. The finer the granularity, the greater number of clusters search words are classified into. Then, the user may be able to variably set this granularity.

FIG. 29 is a diagram showing the mapping image 7 in which the user can set the granularity. A slide bar 30 extending in the horizontal direction is displayed, and the user can set the granularity to be coarse by moving the bar 31 to the left and can set the granularity to be fine by moving the bar 31 to the right. The granularity may have a plurality of stages, and the number of stages is not particularly limited.

FIG. 29 shows a state in which the granularity is set to be coarse. In this example, each search word is classified into one of two clusters A and B, and there are two types of node display modes (black and diagonal lines in the order of A and B).

FIG. 30 is a diagram showing a state in which the granularity is set to be finer than in FIG. 29. In this example, each search word is classified into one of four clusters A1, A2, B1, and B2. Cluster A is further classified into clusters A1 and A2, and cluster B is further classified into clusters B1 and B2. In this case, there are four types of node display modes (black, white, diagonal lines, and wavy lines in the order of A1, A2, B1, B2).

In this way, each time the granularity is set (changed) according to the user operation, each search word is classified into a cluster according to the set granularity. Then, when the cluster into which each search word is classified changes, the display mode of the node is also automatically updated.

For example, when trying to create a Web page related to the technology “ABC” in general, it is possible to grasp a wide range of relatively highly relevant search words by setting the granularity to be coarse. On the other hand, when trying to create a Web page specialized for a specific technology among the technologies called “ABC”, it is possible to grasp a small number of particularly highly relevant search words with high accuracy by setting the granularity to be fine.

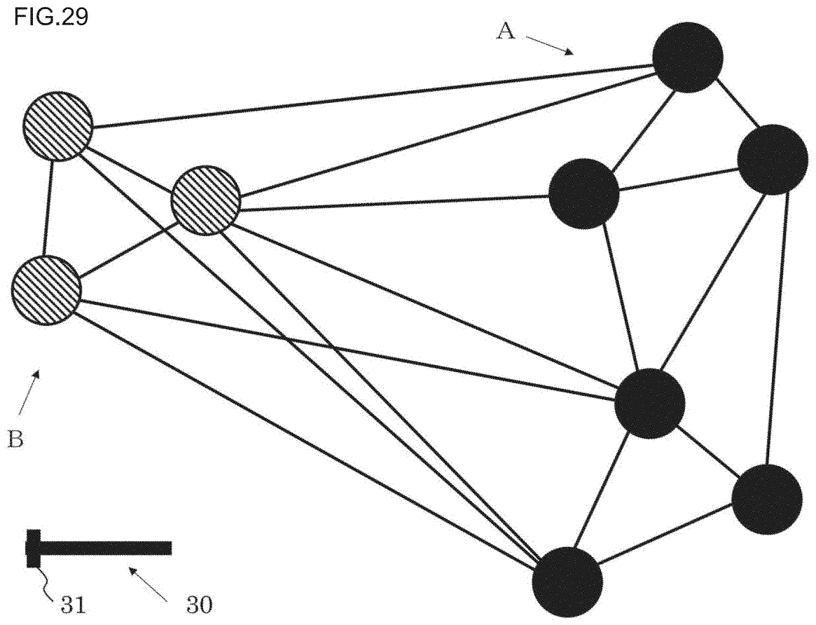

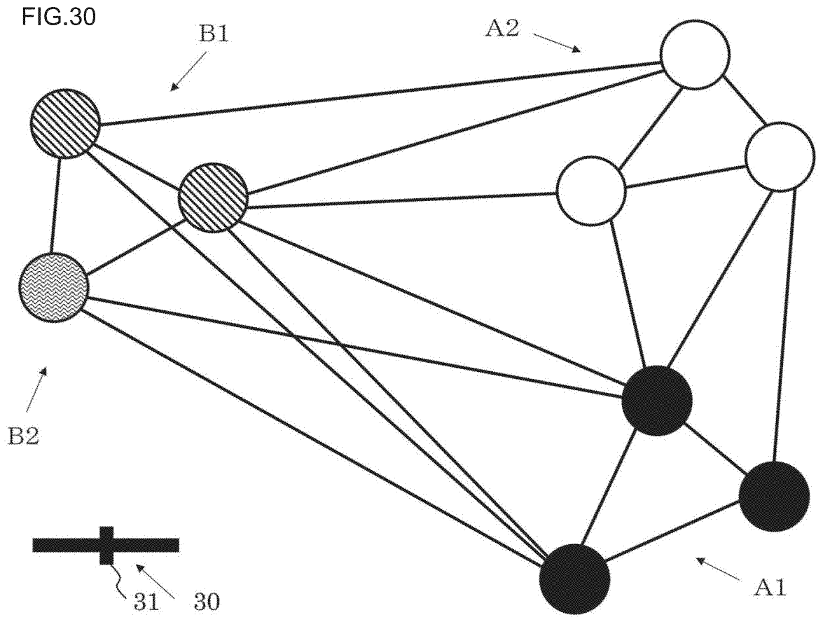

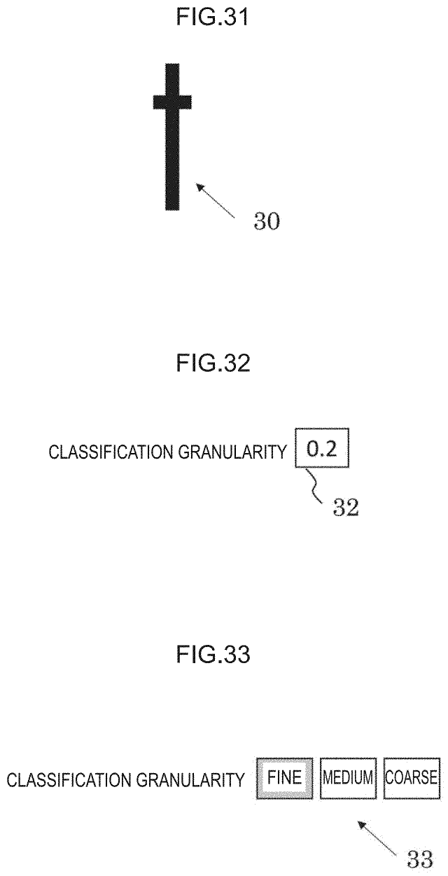

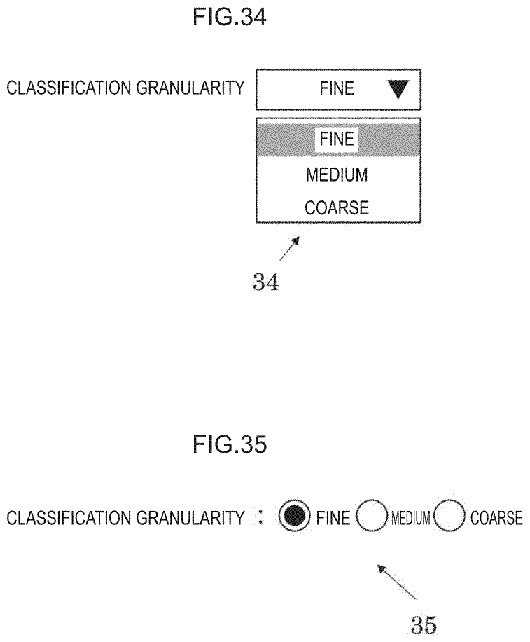

The granularity adjustment interface is not limited to the slide bar 30 shown in FIGS. 29 and 30. As shown in FIG. 31, the slide bar 30 extending in the vertical direction may be used. As shown in FIG. 32, a field 32 may be provided in which the user inputs a numerical value indicating the granularity. As shown in FIG. 33, the user may select the button (icon) 33 showing the granularity. The user may select from a pull-down 34 as shown in FIG. 34 or a radio button 35 as shown in FIG. 35. Other interfaces not illustrated may be used, but preferably an interface that allows the user to selectively select one of a plurality of stages.

Further, the number of searches for each search word may be shown on the mapping screen 7.

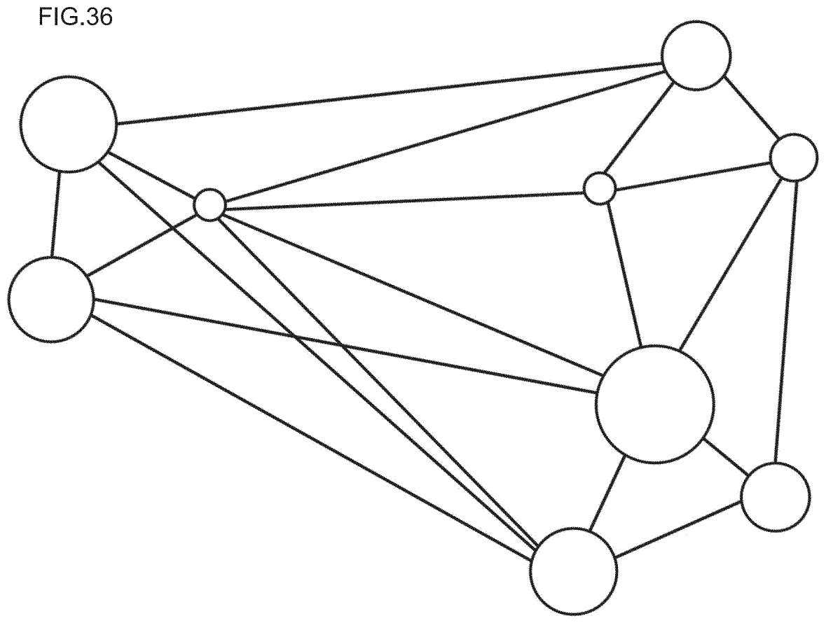

FIG. 36 is a diagram showing the mapping image 7 in which nodes are displayed in a style corresponding to the number of searches for each search word. The larger the number of searches for the search word associated with the node, the larger the node will be displayed. It is easy and intuitive to understand that the search word associated with the largely displayed node should be emphasized. The number of searches may be the number of searches in a certain period (for example, the latest one month). Of course, the user may be able to set the period variably, for example, it may be possible to compare what kind of change has occurred between the last one month and two months ago.

By combining each of the above examples, the node corresponding to a certain search word may be displayed in a mode corresponding to the cluster into which the search word is classified and in a size corresponding to the number of searches of the search word. In addition, different additional information may be added to the undirected graph.

As described above, in the present embodiment, the analysis result for the search word is displayed with an undirected graph. Therefore, the user can intuitively understand the analysis results such as the similarity between the search words and how they are clustered, and it is easy to select the search word to be targeted.

### Eleventh Embodiment

The following is a modification of the display mode of the analysis result.

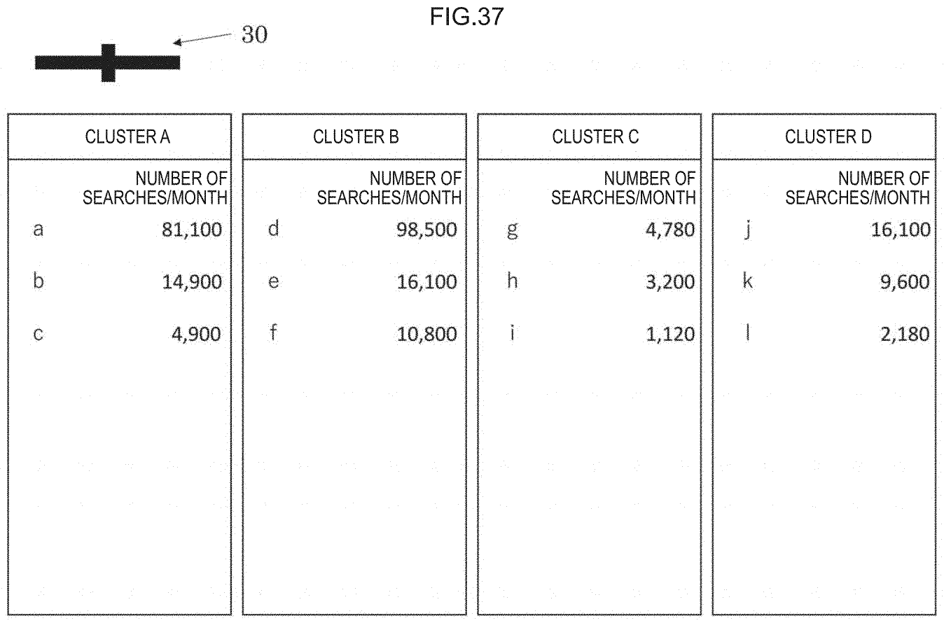

FIG. 37 is a diagram showing a screen example when the analysis result is displayed in a tabular format. Each search word is classified into one of four clusters A to D, and the search words classified in each cluster are displayed in a table format associated with the cluster. In the figure, it can be seen that the search words a to c are classified into cluster A, for example.

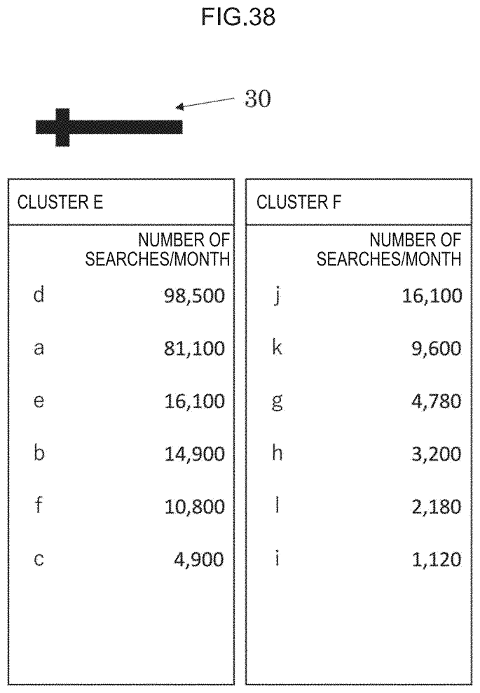

In this case, it is desirable for the user to be able to adjust the granularity. For example, in FIG. 37, search words are classified into four clusters, but when the user sets the granularity to be coarse by using the slide bar 30, they are classified into two clusters E and F as shown in FIG. 38. As in the case of the undirected graph, each time the granularity is set (changed) according to the user operation, each search word is classified into a cluster according to the set granularity. Then, when the cluster into which each search word is classified changes, the table is automatically updated.

Further, as shown in FIGS. 37 and 38, the number of searches may be associated with each search word and displayed. In this case, it is desirable that the search word having a large number of searches is placed above.

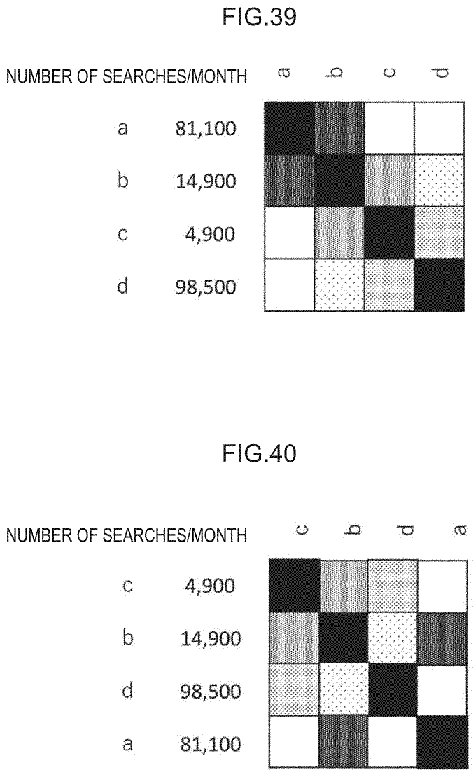

FIG. 39 is a diagram showing a screen example when the analysis result is displayed in the correlation matrix format. Search words a to d are aligned side by side in the vertical and horizontal directions. Then, the similarity between the search words is shown in the cell at the intersection of the vertical direction and the horizontal direction. As the similarity, a numerical value may be displayed in the cell, or the cell may be displayed in a mode according to the similarity (in FIG. 39, the density of the spot is used to indicate the pseudo density, for example, the higher the similarity, the darker the cell). Further, the number of searches may be associated with each search word and displayed.

Further, the user may change the order of the search words. As an example, when the user selects a desired search word, the selected search word may be placed at the top, and other search words may be placed from the top in descending order of the similarity with the search word. Assume that the user selects the search word c in FIG. 39. In this case, as shown in FIG. 40, the search word c is aligned at the top, and the search words b, d, and a are aligned below the search word c in descending order of the similarity with the search word c.

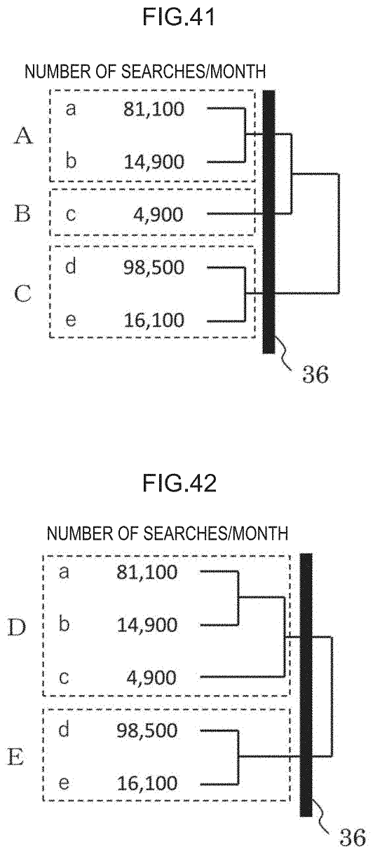

FIG. 41 is a diagram showing a screen example when the analysis result is displayed in the dendrogram format. The search words are aligned vertically, and the search words with a high similarity are placed close to each other. It is shown that the search words are stepwisely classified into clusters toward the right (direction away from the search words).

In order to make the stepwise clustering easier to see, as in FIG. 4, a granularity setting bar (evaluation axis setting bar) 36 extending in the direction orthogonal to the dendrogram (vertical direction, direction in which search words are lined up) is desirably displayed on the dendrogram. The user can move the granularity setting bar 36 left and right, and the granularity is coarser as the granularity setting bar 36 is moved to the right (away from the search word).

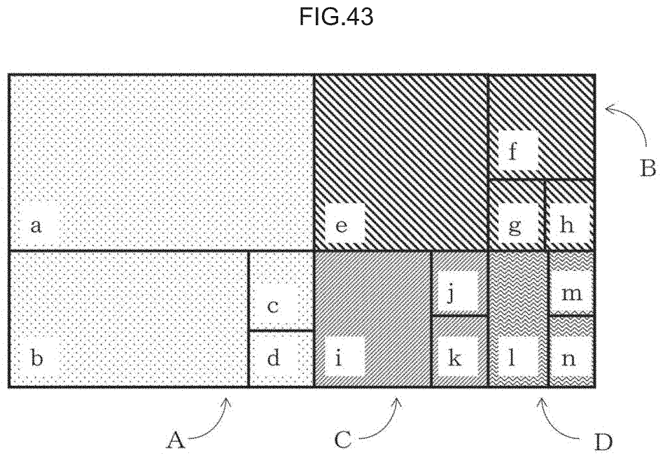

For example, when the granularity setting bar 36 is moved to the position shown in FIG. 41, the search word is classified into one of the three clusters A, B, and C, and when the granularity setting bar 36 is moved to the position shown in FIG. 42, the search word is classified into one of two clusters D and E.

As shown in FIGS. 41 and 42, the number of searches may be associated with each search word and displayed. Further, the dendrogram may have search words aligned in the horizontal direction. Further, the granularity setting bar 36 may set the granularity intuitively, but another interface as described in the tenth embodiment may be used to set the granularity.

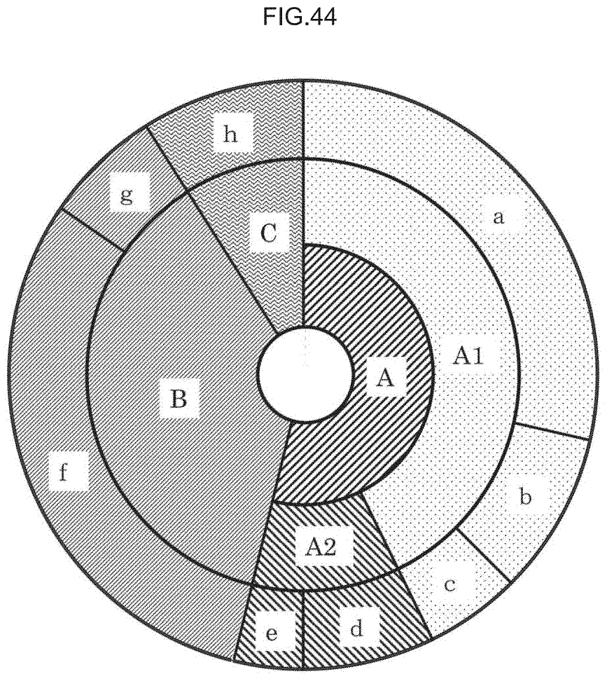

FIG. 43 is a diagram showing a screen example when the analysis result is displayed in the tree map format. Each search word a to n is classified into one of four clusters A to D. One rectangular cell corresponds to one search word, and the display mode of the cell (for example, the color of the cell, in the figure, pseudo colors are shown in spots, diagonal lines, and wavy lines) indicates classified clusters, and the cell area indicates the number of searches in a predetermined period.

FIG. 44 is a diagram showing a screen example when the analysis result is displayed in the sunburst format. One Baumkuchen-type cell on the outermost side corresponds to each of the search words a to h. The cells on the inside show the clusters into which search words are classified, and the inside of the same layer is the clusters with the same granularity. For example, the innermost layer has three coarse clusters A to C, search words a to e are classified into cluster A, search words f and g are classified into cluster B, and search word h is classified into cluster C. The second layer from the inside has clusters A1 and A2, and cluster A is divided into two finer clusters A1 and A2, and search words are classified into a total of four clusters A1, A2, B, and C. The display mode of the cell (for example, the color of the cell, in the figure, pseudo colors are shown in spots, diagonal lines, and wavy lines) may indicate classified clusters, and the cell size may indicate the number of searches in a predetermined period.

According to the tree map format and the sunburst format, it is possible to intuitively grasp the identification result and the number of searches. Even in these formats, it is desirable that the user can set the granularity variably.

### Modification

Although the first to eleventh embodiments of the present invention have been described above, the following description may be added to the embodiments.
(1) In the analysis result output process of the first to third embodiments described above, the top-ranking page identification is outputted as the analysis result. However, one or a plural combination of the following four types of information may be outputted as the analysis result.

First, after classifying the document data Dₖ (k=1 to d) into a plurality of subsets by an identification process such as clustering, classification, or community detection, the needs purity of the search to be evaluated may be obtained based on the plurality of subsets to output the needs purity as an analysis result. Here, the needs purity is an index indicating whether the variation in the properties of the needs purity in the search results is small or large. When the search result of a certain search word is occupied by web pages having the same property, the needs purity of the search word is high. When the search word of a certain search word is occupied by web pages having different properties, the needs purity of the search word is low. The procedure for calculating the needs purity when the identification process is clustering/classification and when the identification process is community detection is as follows.

### a1. When the Identification Process is Clustering/Classification

In this case, the variance of the document data Dₖ (k=1 to d) is calculated, and the needs purity is calculated based on this variance. More specifically, the average of all coordinates of the feature vector data z₁={z₁₁, z₁₂ . . . z₁₁}, z₂={z₂₁, z₂₂ . . . z₂ₗ} . . . z_{d}={z_{d1}, z₂ . . . z_{dl}} of the document data D₁, D₂ . . . D_{d} is calculated. Next, the distance from the average of all coordinates of the feature vector data z₁={z₁₁, z₁₂ . . . z₁ₗ} of the document data D₁, the distance from the average of all coordinates of the feature vector data z₂={z₂₁, z₂₂ . . . z₂ₗ} of the document data D₂ . . . the distance from the average of all coordinates of the feature vector data z_{d}={z_{d1}, z_{d2} . . . z_{dl}} of the document data D_{d} are obtained. Next, the variance of the distance from the average of all coordinates of the document data D₁, D₂ . . . D_{d} is obtained, and this variance is set as the needs purity. The needs purity may be calculated based on the intra-cluster variance/intra-class variance instead of the variance of the distance from the average of all coordinates of the document data D₁, D₂ . . . D_{d}.

### b1. When the Identification Process is Community Detection

In this case, the average path length between the nodes of the document data Dₖ in the undirected graph is calculated, and the needs purity is calculated based on this average path length. More specifically, a threshold of the similarity between document data Dₖ is set, and an unweighted undirected graph without edges below the threshold is generated. Next, the average path length between the nodes in this unweighted undirected graph is calculated, and the reciprocal of the average path length is used as the needs purity. Similarly, the cluster coefficient, assortativity, centrality distribution, and edge intensity distribution are obtained, and the values obtained by applying the cluster coefficient, assortativity, centrality distribution, and edge intensity distribution to a predetermined function may be set as the needs purity.

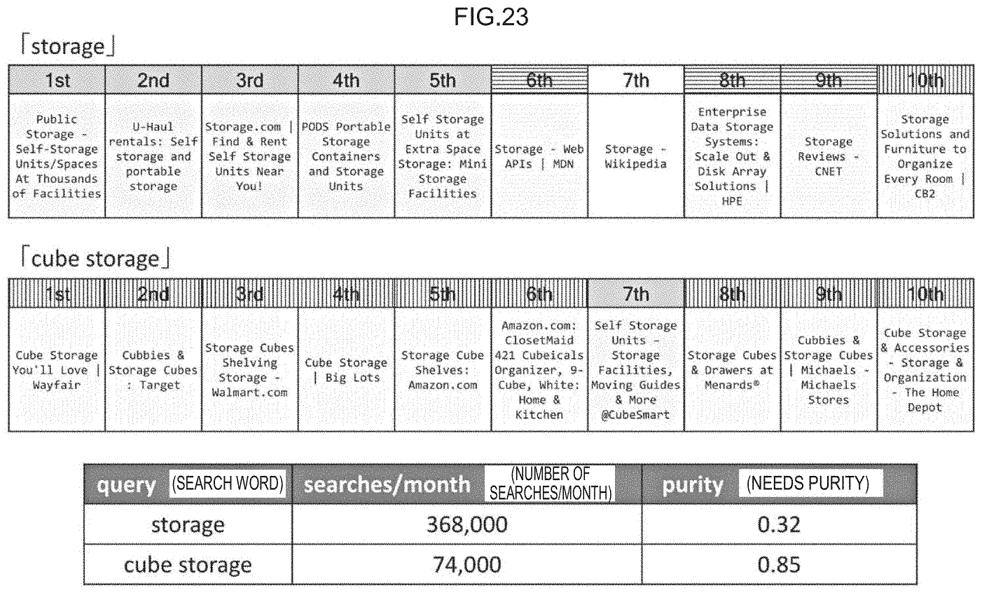

According to this modification, for example, as shown in FIG. 23, a first search word (in the example in FIG. 23, storage) and a second search word that includes the first search word (in the example in FIG. 23, cube storage) are candidates for the SEO. When there is a difference in the number of searches per month for the two search words, by comparing the number of searches and needs purity of the first search word with the number of searches and needs purity of the second search word, it is easy to determine which search word is prioritized in the SEO.

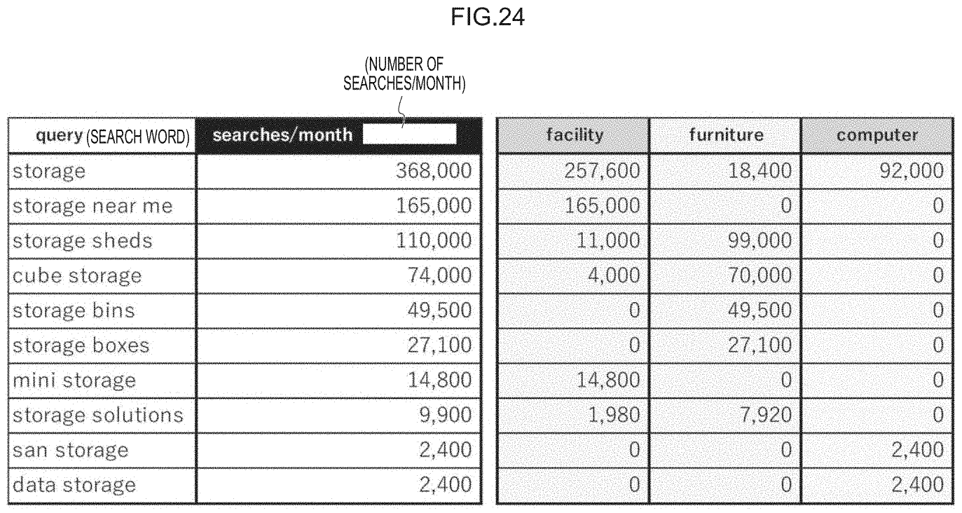

Second, as shown in FIG. 24, when a first search word (in the example in FIG. 24, storage) and a plurality of second search words including the first search word (in the example of FIG. 24, storage near me, storage sheds, cube storage, storage bins, storage boxes, mini storage, storage solutions, san storage, data storage) are to be evaluated, a list summarizing the product of the number of searches per month for each of a plurality of search words and the ratio of each subset to the entire document data Dₖ (k=1 to d) may be outputted as the analysis result.

According to this modification, the first search word and the plurality of second search words that include the first search word are candidates for the SEO, and when there is a difference in the number of searches for a plurality of search words per month, it is easy to determine which search word is prioritized in the SEO. This modification is suitable for evaluating a search word with low needs purity.

Moreover, this second modification may be applied to the search-linked advertisement. When the second modification is applied to a search-linked advertisement, it is possible to improve the accuracy of the advertisement related to the search word when a plurality of search needs exists for one search word. For example, in the case of search-linked advertisement related to “storage” shown in the example of FIG. 24, it will be possible to determine what percentage of facility-type advertisements should be displayed, what percentage of furniture-type advertisements should be displayed, and what percentage of computer-type advertisements should be displayed.

Third, the B degree, which is an index showing how much the top-ranking web pages of the search word to be evaluated meets the business needs, and the C degree, which is an index showing how much the top-ranking web pages of the search word to be evaluated meets the consumer needs may be obtained to output the B degree and the C degree as an analysis result. The procedure for calculating the B degree and the C degree when the identification process is classification is as follows.

First, a feature vector data group associated with the label information indicating that it is B to B teacher data, a feature vector data group associated with the label information indicating that it is B to C teacher data, and a feature vector data group associated with the label information indicating that it is C to C teacher data are prepared to set the weighting coefficients of the linear classifier f(z) to be suitable for the identification of B to B, B to C, and C to C by machine learning using these groups.

After optimizing the weighting coefficients by machine learning, the feature vector data z₁={z₁₁, z₁₂ . . . z_{1l′}} of the document data D₁ is substituted into the linear classifier f(z) to determine which class the document data D₁ belongs to, the feature vector data z₂={z₂₁, z₂₂ . . . z_{2l′}} of the document data D₂ is substituted into the linear classifier f(z) to determine which class the document data D₂ belongs to . . . the feature vector data z_{d}={z_{d1}, z_{d2} . . . z_{dl′}} of the document data Dₙ is substituted into the linear classifier f(z) to determine which class the document data D, belongs to, thereby classifying the document data D₁, D₂ . . . D_{d} into B to B class, B to C class, and C to C class. Then, the B degree and the C degree are calculated based on the relationship of the ratio of each class of B to B, B to C, and C to C to the entire document data Dₖ (k=1 to d).

By the same procedure, the degree of academy, which is an index showing how much the top-ranking web pages of the search word to be evaluated meet the academic needs, and the degree of conversation, which indicates how much the top-ranking web pages of the search word to be evaluated meets the conversational needs may be obtained to output these indexes as an analysis result.
(2) In the first to ninth embodiments described above, the web page in the search result is to be analyzed. However, web sites and web contents may be analyzed.
(3) In the quantification process of the first to ninth embodiments described above, only the contents of the document data Dₖ (k=1 to d) may be quantified, and the identification process may be performed on the feature vector data obtained by quantifying this content. Further, in the quantification process, only the structure of the document data Dₖ (k=1 to d) may be quantified, and the identification process may be performed on the feature vector data obtained by quantifying this content.
(4) In the document content quantification process of the first to ninth embodiments described above, the document data Dₖ (k=1 to d) may be summarized by an automatic sentence summarization algorithm, this summarized document data may be converted into a multidimensional vector, and all or part of the process after step S210 may be performed on the feature vector data converted into the multidimensional vector.
(5) In the document structure quantification process of the first to ninth embodiments described above, the structure of the document data Dₖ (k=1 to d) may be quantified based on the composition ratio of parts of speech, the HTML tag structure, the modification structure, and the structure complexity.
(6) In the evaluation axis setting process of the first and third embodiments described above, the number of identifications (number of clusters and communities) is set by moving the evaluation axis setting bar 9 to the upper hierarchy side or the lower hierarchy side. On the other hand, as shown in FIG. 4(B), the number of identifications may be set in a setting manner in which part (in the example of FIG. 4(B), the portion indicated by the chain line) of a plurality of subsets in the same hierarchy is excluded from the identification target.
(7) In the clustering process of the first, fourth, and fifth embodiments described above, the nearest neighbor method of clustering is performed on the feature vector data z₁={z₁₁, z₁₂ . . . z_{1′}}, z₂={z₂₁, z₂₂ . . . z_{2l′}} . . . z_{d}={z_{d1}, z_{d2} . . . z_{dl′}} of the document data D₁, D₂ . . . D_{d}.

However, a process other than the nearest neighbor method may be performed. For example, the process according to an algorithm of Ward's method, group average method, nearest neighbor method, furthest neighbor method, or Fuzzy C-means method may be performed on the feature vector data z₁={z₁₁, z₁₂ . . . z_{1l′}}, z₂={z₂₁, z₂₂ . . . z_{2l′}} . . . z_{d}={z_{d1}, z_{d2} . . . z_{dl′}} of the document data D₁, D₂ . . . D_{d}.

In addition, the clustering process using deep learning may be performed on the feature vector data z₁={z₁₁, z₁₂ . . . z_{1l′}}, z₂={z₂₁, z₂₂ . . . z₂ₗ′} . . . z_{d}={z_{d1}, z_{d2} . . . z_{dl′}} of the document data D₁, D₂ . . . D_{d}.

In addition, the process according to a non-hierarchical clustering algorithm such as k-means may be performed on the feature vector data z₁={z₁₁, z₁₂ . . . z_{1′}}, z₂={z₂₁, z₂₂ . . . z_{2l′}} . . . z_{d}={z_{d1}, z_{d2} . . . z_{dl′}} of the document data D₁, D₂ . . . D_{d}. Here, since k-means is a non-hierarchical clustering, the dendrogram 8 cannot be presented as an analysis result. In the case of k-means clustering, in the evaluation axis setting process, it is preferable to accept the input of the value k of the number of clusters from the user and perform the clustering process with the specified number of clusters as a new setting.
(8) In the classification process of the second, sixth, and seventh embodiments described above, the CPU 22 determines to which class each of the document data Dₖ (k=1 to d) is distributed by the so-called perceptron linear classifier f(z). However, the data may be distributed to the class by another method. For example, the document data Dₖ (k=1 to d) may be classified into a plurality of classes by perceptron, naive Bayesian method, template matching, k-nearest neighbor method, decision tree, random forest, AdaBoost, Support Vector Machine (SVM), or deep learning. Further, the identification may be performed by a non-linear classifier instead of the linear classifier.
(9) In the community detection process of the third, eighth, and ninth embodiments described above, the document data Dₖ (k=1 to d) is converted into a weighted undirected graph, and by repeating calculation of betweenness of each node in a weighted undirected graph, and the removal of the edge with the maximum betweenness, the document data Dₖ (k=1 to d) is classified into a plurality of communities. However, the document data Dₖ (k=1 to d) may be classified into a plurality of communities by a method other than that based on betweenness. For example, the document data Dₖ (k=1 to d) may be classified into a plurality of communities by random walk-based community detection, greedy method, eigenvector-based community detection, multilevel optimization-based community detection, spinglass-based community detection, Infomap method, or the Overlapping Community Detection-based community detection.
(10) In the community detection process of the fifth to sixth embodiments described above, an unweighted undirected graph with each of the document data Dₖ (k=1 to d) as a node may be generated, and the document data Dₖ (k=1 to d) may be classified into a plurality of communities based on this unweighted undirected graph.
(11) In the analysis result output process of the fourth and fifth embodiments described above, the top ranking page identification and the mapping image 7 based on the processing result of the clustering process may be outputted as the analysis result screen. Further, in the analysis result output process of the sixth and seventh embodiments described above, the top-ranking page identification and the mapping image 7 based on the processing result of the classification process may be outputted as the analysis result screen. Further, in the analysis result output process of the eighth and ninth embodiments described above, the top-ranking page identification and the mapping image 7 based on the processing result of the community detection process may be outputted as the analysis result screen.
(12) In the first, second, fourth, fifth, sixth, and seventh embodiments described above, the identification process such as clustering or classification may be performed on the processing result of the addition process without performing the dimension reduction process. In addition, in the third, eighth, and ninth embodiments, the dimension reduction process may be performed, the similarity identification process and the community detection process may be performed on the feature vector data that has undergone dimensional reduction by the dimension reduction process, and a plurality of document data may be classified into a plurality of subsets with the feature vector data that has undergone the dimensional reduction process.

### REFERENCE SIGNS LIST

1 evaluation system

10 user terminal

20 search needs evaluation apparatus

21 communication interface

22 CPU

23 RAM

24 ROM

25 hard disk

26 evaluation program

50 search engine server apparatus

1. (canceled)

2. The search needs evaluation apparatus according to claim 22, wherein
the display control means
moves a specific node according to a user operation, and
moves at least one node connected to the specific node through an edge according to a movement of the specific node.

3. The search needs evaluation apparatus according to claim 22, comprising:
an identification means that classifies each search word into a cluster in accordance with the search needs based on a search result for each of the plurality of search words, wherein
the display control means displays a node in a display mode corresponding to a cluster into which each search word is classified in accordance with the search needs.

4. The search needs evaluation apparatus according to claim 3, wherein
the identification means is capable of calculating how close each search word is to each of two or more of the clusters, and
the display control means displays a node in a display mode according to how close each search word is to which cluster.

5. The search needs evaluation apparatus according to claim 3, wherein the identification means is capable of classifying each search word into a cluster with a plurality of stages of granularity, and each time a granularity is set according to a user operation, classifies each search word into a cluster according to the set granularity.

6. The search needs evaluation apparatus according to claim 5, wherein the display control means changes a display mode of a node when a granularity is changed according to a user operation and thus a cluster into which each search word is classified changes.

7. The search needs evaluation apparatus according to claim 22, wherein the display control means displays a node in a display mode according to a number of searches for each search word in a certain period.

8. The search needs evaluation apparatus according to claim 22, comprising:
a quantification means that converts at least one of a content and a structure of document data which is a search result for each of a plurality of search words into multidimensional feature vector data, wherein
the similarity acquisition means acquires a similarity between each search word based on a similarity between the feature vector data for each search word.

9.-10. (canceled)

11. A search needs evaluation apparatus comprising:
an acquisition means that acquires a plurality of document data in a search result based on a certain search word which may comprise a plurality of search needs;
a quantification means that converts at least one of a content and a structure of the plurality of document data into multidimensional feature vector data;
an identification means that classifies the plurality of document data into a plurality of subsets based on the feature vector data; and
an analysis result output means that outputs an analysis result of a property of search needs relating to how much different search needs are mixed in each search word based on a relationship between the plurality of subsets.

12. The search needs evaluation apparatus according to claim 11, wherein the identification means performs a process on the feature vector data according to a clustering algorithm or a classification algorithm, and classifies the plurality of document data into a plurality of subsets.

13. The search needs evaluation apparatus according to claim 11, wherein
the acquisition means acquires document data in a search result for each search word for each of a plurality of search words,
the quantification means converts at least one of a content and a structure of the plurality of document data in the search result for each search word into multidimensional feature vector data, and
the search needs evaluation apparatus includes a combining means that performs a predetermined statistical process on feature vector data for each document obtained by the quantification means, and that combines the feature vector data for each search word.

14. The search needs evaluation apparatus according to claim 11, wherein
the acquisition means acquires document data in a search result for each search word for each of a plurality of search words,
the quantification means converts at least one of a content and a structure of the plurality of document data in the search result for each search word into multidimensional feature vector data,
the identification means classifies the plurality of document data into a plurality of subsets based on feature vector data for each document, and
the search needs evaluation apparatus includes a combining means that performs a predetermined statistical process on a processing result by the identification means, and that combines the processing result for each search word.

15. The search needs evaluation apparatus according to claim 11, comprising:
a dimension reduction means that dimensionally reduces the feature vector data to lower dimensional feature vector data, wherein
the identification means classifies the plurality of document data into a plurality of subsets based on the feature vector data that has undergone the dimension reduction by the dimension reduction means.

16. A search needs evaluation apparatus comprising:
an acquisition means that acquires a plurality of document data in a search result based on a certain search word which may comprise a plurality of search needs;
a quantification means that converts at least one of a content and a structure of the plurality of document data into multidimensional feature vector data;
a similarity identification means that identifies a similarity between feature vector data of the plurality of document data;
a community detection means that classifies the plurality of document data into a plurality of communities based on the similarity; and
an analysis result output means that outputs an analysis result of search needs relating to how much different search needs are mixed in each search word based on a relationship between the plurality of communities.

17. The search needs evaluation apparatus according to claim 16, wherein
the acquisition means acquires document data in a search result for each search word for each of a plurality of search words,
the quantification means converts at least one of a content and a structure of the plurality of document data in the search result for each search word into multidimensional feature vector data,
the similarity identification means identifies a similarity between feature vector data of the plurality of document data for each search word,
the community detection means classifies the plurality of document data for each search word into a plurality of communities based on the similarity between the feature vector data of the plurality of document data for each search word, and
the search needs evaluation apparatus includes a combining means that performs a predetermined statistical process on a processing result of a community detection for each search word by the community detection means, and that combines the processing result of the community detection for each search word.

18. A search needs evaluation method comprising:
an acquisition step of acquiring a plurality of document data in a search result based on a certain search word which may comprise a plurality of search needs;
a quantification step of converting at least one of a content and a structure of the plurality of document data into multidimensional feature vector data;
an identification step of classifying the plurality of document data into a plurality of subsets based on the feature vector data; and
an analysis result output step of outputting an analysis result of a property of search needs relating to how much different search needs are mixed in each search word based on a relationship between the plurality of subsets.

19. A search needs evaluation method comprising:
an acquisition step of acquiring a plurality of document data in a search result based on a certain search word which may comprise a plurality of search needs;
a quantification step of converting at least one of a content and a structure of the plurality of document data into multidimensional feature vector data;
a similarity identification step of identifying a similarity between feature vector data of the plurality of document data;
a community detection step of classifying the plurality of document data into a plurality of communities based on the similarity; and
an analysis result output step of outputting an analysis result of search needs relating to how much different search needs are mixed in each search word based on a relationship between the plurality of communities.

20. A search needs evaluation program causing a computer to execute:
an acquisition step of acquiring a plurality of document data in a search result based on a certain search word which may comprise a plurality of search needs;
a quantification step of converting at least one of a content and a structure of the plurality of document data into multidimensional feature vector data;
an identification step of classifying the plurality of document data into a plurality of subsets based on the feature vector data; and
an analysis result output step of outputting an analysis result of a property of search needs relating to how much different search needs are mixed in each search word based on a relationship between the plurality of subsets.

21. A search needs evaluation program causing a computer to execute:
an acquisition step of acquiring a plurality of document data in a search result based on a certain search word which may comprise a plurality of search needs;
a quantification step of converting at least one of a content and a structure of the plurality of document data into multidimensional feature vector data;
a similarity identification step of identifying a similarity between feature vector data of the plurality of document data;
a community detection step of classifying the plurality of document data into a plurality of communities based on the similarity; and
an analysis result output step of outputting an analysis result of search needs relating to how much different search needs are mixed in each search word based on a relationship between the plurality of communities.

22. A search needs evaluation apparatus comprising:
a similarity acquisition means configured to, based on a search result for each of a plurality of search words each may include a plurality of search needs, utilizing that search needs of each of the search words is reflected on the search result of the search words, acquire a similarity of search needs between each of the search words and other plurality of search words; and
a display control means configured to display a screen comprising a plurality of nodes and an edge, each of the search words being associated with each of the nodes, the edge connecting the nodes, wherein in the screen, as the similarity of search needs between one search word and another search word is higher, one node associated with the one search word is aligned closer to another node associated with the another search word,
wherein a length of the edge corresponds to a similarity between the search words associated with the nodes connected through the edge, and
wherein one edge among the plurality of edges connected to one node associated with one search word corresponds to one search needs, and another edge among the plurality of edges connected to the one node associated with the one search word corresponds to another search needs.

23. The search needs evaluation apparatus according to claim 22, wherein the similarity acquisition means is configured to acquire the similarity of search needs utilizing a predetermined top number of documents included in the search result.

24. A search needs evaluation method comprising:
based on a search result for each of a plurality of search words each may include a plurality of search needs, utilizing that search needs of each of the search words is reflected on the search result of the search words, acquiring a similarity of search needs between each of the search words and other plurality of search words; and
displaying a screen comprising a plurality of nodes and an edge, each of the search words being associated with each of the nodes, the edge connecting the nodes, wherein in the screen, as the similarity of search needs between one search word and another search word is higher, one node associated with the one search word is aligned closer to another node associated with the another search word,
wherein a length of the edge corresponds to a similarity between the search words associated with the nodes connected through the edge, and
wherein one edge among the plurality of edges connected to one node associated with one search word corresponds to one search needs, and another edge among the plurality of edges connected to the one node associated with the one search word corresponds to another search needs.

25. A search needs evaluation program to cause a computer to function as:
a similarity acquisition means configured to, based on a search result for each of a plurality of search words each may include a plurality of search needs, utilizing that search needs of each of the search words is reflected on the search result of the search words, acquire a similarity of search needs between each of the search words and other plurality of search words; and
a display control means configured to display a screen comprising a plurality of nodes and an edge, each of the search words being associated with each of the nodes, the edge connecting the nodes, wherein in the screen, as the similarity of search needs between one search word and another search word is higher, one node associated with the one search word is aligned closer to another node associated with the another search word,
wherein a length of the edge corresponds to a similarity between the search words associated with the nodes connected through the edge, and
wherein one edge among the plurality of edges connected to one node associated with one search word corresponds to one search needs, and another edge among the plurality of edges connected to the one node associated with the one search word corresponds to another search needs.
